(19) United States
(12) Patent Application Publication
(10) Pub. No.: US 2017/0357608 A1
(43) Pub. Date: Dec. 14, 2017

(54) INFORMATION PROCESSING SYSTEM, INFORMATION PROCESSING METHOD, AND INFORMATION PROCESSING DEVICE

(71) Applicant: NEC Corporation, Tokyo (JP)

(72) Inventor: Yoshikazu KOBAYASHI, Tokyo (JP)

(21) Appl. No.: 15/527,987

(22) PCT Filed: Nov. 18, 2015
(86) PCT No.: PCT/JP2015/082359

§ 371 Date: May 18, 2017

(30) Foreign Application Priority Data
Nov. 19, 2014 (JP) 2014-235108

(51) Int. Cl. G06F 13/42; G06F 13/38

(52) U.S. Cl. CPC G06F 13/4282; G06F 13/385; G06F 2213/3804; G06F 2213/0042

(57) ABSTRACT

This information processing system uses a simple configuration to control a remote device by employing a unified communication channel (pipe) from an application to the device. The information processing system is provided with: a device; a device control unit for controlling the device; a device interface unit for interfacing with the device control unit; an information processing device provided with an application, and an application interface unit for interfacing with the application; and a channel establishment unit which connects, via a communication unit, the application interface unit and the device interface unit, and establishes a control channel and a data channel between the application and the device.

### CROSS-REFERENCE TO RELATED PATENT APPLICATIONS

This application is a National Stage Entry of International Application No. PCT/JP2015/082359, filed Nov. 18, 2015, which claims priority from Japanese Patent Application No. 2014-235108, filed Nov. 19, 2014. The entire contents of the above-referenced applications are expressly incorporated herein by reference.

### TECHNICAL FIELD

The present invention relates to an information processing system, an information processing method, a device, an information processing device, a communication terminal, and a control method and a control program therefor.

### BACKGROUND ART

In the aforementioned technical field, PTL 1 discloses a technology of connecting a function driver and a hob driver that constitute a device driver, by communication through a network, and controlling a USB device.

### CITATION LIST

### Patent Literature

[PTL 1] Japanese Unexamined Patent. Application Publication No. 2013-016165

### SUMMARY OF INVENTION

### Technical Problem

However, in die technology described in the aforementioned literature, network communication is not directly associated with USB communication, and a communication channel (pipe) is divided, thus featuring an extra configuration.

An object of the present invention is to provide a technology solving the problem described above.

### Solution to Problem

To achieve the object of the present invention, an information processing system recited in the present invention includes:

a device control unit that controls the device;

a device interface unit that interfaces with the device control unit;

an information processing device that includes an application and an application interface unit that interfaces with the application; and

a channel establishment unit that, when being connected to the application interface unit and the device interface unit, establishing a control channel and a data channel between the application and the device.

To achieve the object of the present invention, an information processing method recited in the present invention includes:

by an information processing device,

initiating an application;

activating an application interface unit that interfaces with the application;

connecting, through a communication unit, the application interface unit to a device interface unit that interfaces with a device control unit that controls a device; and

establishing a control channel and a data channel between the application and the device.

To achieve the object of the present invention, an information processing device recited in the present invention includes:

an application;

an application interface unit that interfaces with the application; and

a channel establishment unit that connects, through a communication unit, the application interface unit to a device interface unit that interfaces with a device control unit that controls a device, and establishes a control channel and a data channel between the application and the device.

To achieve the object of the present invention, a non-transitory program storage medium storing a control program for an information processing device causes a computer to perform:

initiating an application;

activating an application interface unit that interfaces with the application;

connecting, through a communication unit, the application interface unit to a device interface unit that interfaces with a device control unit that controls a device; and

establishing a control channel and a data channel between the application and the device.

To achieve the object of the present invention, a communication terminal recited in the present invention includes:

a device control unit that controls a device;

a device interface unit that interfaces with the device control unit; and

a channel establishment unit that connects, through a communication unit, the device interface unit to an application interface unit that interfaces with an application included in an information processing device, and establishing a control channel and a data channel between the application and the device.

To achieve the object of the present invention, a non-transitory program storage medium storing a control program for a communication terminal recited in the present invention causes a computer to perform:

activating a device interface unit that interfaces with a device control unit that controls a device;

connecting, through a communication unit, the device interface unit to an application interface unit that interfaces with an application included in an information processing device, and

establishing a control channel and a data channel between the application and the device.

To achieve the object of the present invention, a device recited in the present invention includes:

a device control unit that controls the device;

a device interface unit that interfaces with the device control unit; and

a channel establishment unit that connects, through a communication unit, the device interface unit to an application interface unit that interfaces with an application included in an information processing device, and establishing a control channel and a data channel between the application and the device.

### Advantageous Effects of Invention

The present invention is able to control a remote device with a simple configuration by providing a unified communication channel (pipe) ranging from an application to a device.

### BRIEF DESCRIPTION OF DRAWINGS

FIG. 1 is a block diagram illustrating a configuration of an information processing system according to a first example embodiment of the present invention.

FIG. 2A is a block diagram illustrating a configuration of an information processing system according to a second example embodiment of the present invention.

FIG. 2B is a diagram illustrating a concept of the information processing system according to the second example embodiment of the present invention.

FIG. 2C is a diagram illustrating remote connection by a network in die information processing system according to the second example embodiment of the present invention.

FIG. 2B is a diagram illustrating a structure of a communication message according to the second example embodiment of the present invention.

FIG. 2E is a diagram illustrating a format of USB transfer data according to the second example embodiment of the present invention.

FIG. 2F is a diagram illustrating a USB logical protocol according to the second example embodiment of the present invention.

FIG. 3A is a diagram illustrating a concept of an information processing system according to an underlying technology.

FIG. 3B is a diagram illustrating a software configuration of a device driver according to the underlying technology.

FIG. 4 is a block diagram illustrating a functional configuration of an information processing device according to the second example embodiment of the present invention.

FIG. 5 is a block diagram illustrating a functional configuration of a communication terminal according to the second example embodiment of the present invention.

FIG. 6A is a diagram illustrating an information flow in the information processing system according to the second example embodiment of the present invention.

FIG. 6B is a diagram illustrating a communication data structure in the information processing system according to the second example embodiment of the present invention.

FIG. 6C is a diagram illustrating data transmission in the information processing system according to the second example embodiment of the present invention.

FIG. 7A is a sequence diagram illustrating an operation procedure of the information processing system according to the second example embodiment of the present invention.

FIG. 7B is a sequence diagram illustrating an operation procedure of the information processing system according to the second example embodiment of the present invention.

FIG. 7C is a sequence diagram illustrating a detailed communication procedure of the information processing system according to the second example embodiment of the present invention.

FIG. 8 is a block diagram illustrating a. hardware configuration of the information processing device according to the second example embodiment of the present invention.

FIG. 9A is a flowchart illustrating a processing procedure of the information processing device according to the second example embodiment of the present invention.

FIG. 9B is a flowchart illustrating a processing procedure of the information processing device according to the second example embodiment of the present invention.

FIG. 10 is a block diagram illustrating a hardware configuration of the communication terminal according to the second example embodiment of the present invention.

FIG. 11A is a flowchart illustrating a processing procedure of the communication terminal according to she second example embodiment of the present invention.

FIG. 11B is a flowchart illustrating a processing procedure of the communication terminal according to the second example embodiment of the present invention.

FIG. 12 is a diagram illustrating a concept of an information processing system according to a third example embodiment of the present invention.

FIG. 13 is a block diagram illustrating a functional configuration of a USB device according to the third example embodiment of the present invention.

FIG. 14 is a diagram illustrating an information flow in the information processing system according to the third example embodiment of the present invention.

FIG. 15 is a block diagram illustrating a hardware configuration of the USB device according to the third example embodiment of the present invention.

FIG. 16 is a flowchart illustrating a processing procedure of the USB device according to the third example embodiment of the present invention.

FIG. 17 is a diagram illustrating a concept of an information processing system according to a fourth example embodiment of the present invention.

FIG. 18 is a block diagram illustrating a functional configuration of a USB hub according to the fourth example embodiment of the present invention.

FIG. 19 is a diagram illustrating an information flow in the information processing system according to the fourth example embodiment of the present invention.

FIG. 20 is a block diagram illustrating a hardware configuration of the USB hub according to the fourth example embodiment of the present invention.

FIG. 21 is a flowchart illustrating a processing procedure of the USB hub according to the fourth example embodiment of the present invention.

FIG. 22 is a diagram illustrating a concept of an information processing system according to a fifth example embodiment of the present invention.

FIG. 23 is a diagram illustrating an information flow in the information processing system according to the fifth example embodiment of the present invention.

FIG. 24 is a diagram illustrating a concept of an information processing system according to a sixth example embodiment of the present invention.

FIG. 25 is a diagram illustrating an information flow in the information processing system according to the sixth example embodiment of the present invention.

FIG. 26 is a diagram illustrating a concept of an information processing system according to a seventh example embodiment of the present invention.

FIG. 27 is a diagram illustrating an information flow in the information processing system according to the seventh example embodiment of the present invention.

FIG. 28 is a diagram illustrating a concept of an information processing system according to an eighth example embodiment of the present invention.

FIG. 29 is a diagram illustrating a concept of another information processing system according to the eighth example embodiment of the present invention.

FIG. 30 is a diagram illustrating a concept of an information processing system according to a ninth example embodiment of the present invention.

FIG. 31 is a diagram illustrating data transmission in an information processing system according to a tenth example embodiment of the present invention.

FIG. 32 is a diagram illustrating another type of data transmission in the information processing system according to the tenth example embodiment of the present invention.

### DESCRIPTION OF EMBODIMENTS

Referring to the drawings, example embodiments of the present invention will be exemplarily described below in detail. It is noted that components described in the following example embodiments are merely exemplifications and are not intended to limit the technical scope of the present invention thereto.

<First Example Embodiment>

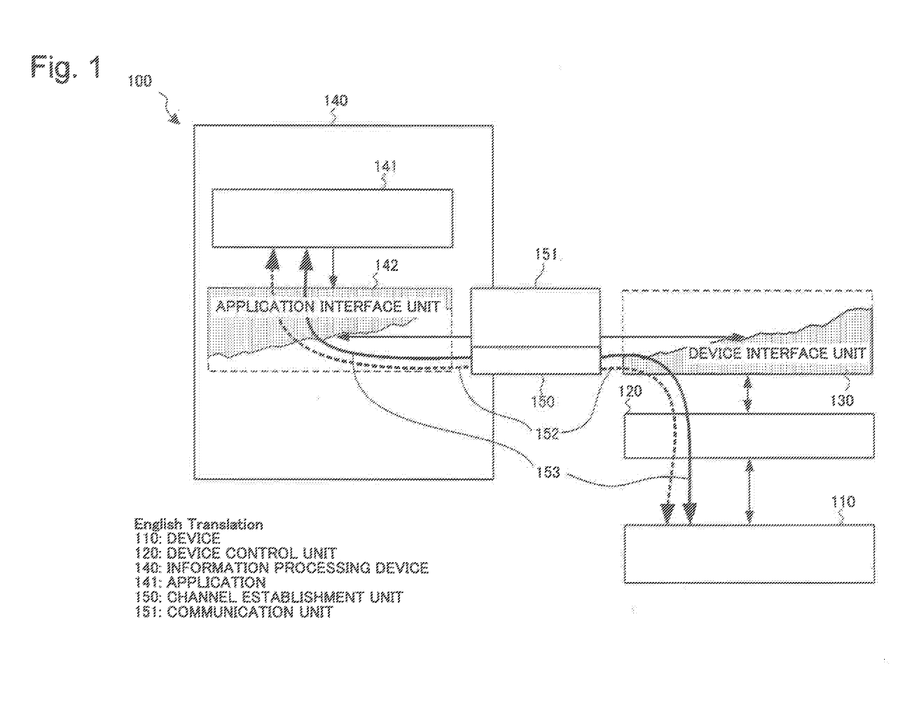

An information processing system 100 according to a first example embodiment of the present invention will be described using FIG. 1. The information processing system 100 is a system controlling a connected device,

As illustrated in FIG. 1, the information processing system 100 includes a device 110, a device control unit 120, a device interface unit 130, an information processing device 140, and a channel establishment unit 150. The device control unit 120 controls die device 110, The device Interface unit 130 interfaces with the device control unit 120. The information processing device 140 includes an application 141 and an application interface unit 142 interfacing with the application 141. The channel establishment unit ISO connects the application interface unit 142 and the device interface unit 130 through a communication unit 151, and establishes a control channel 152 and a data channel 153 between the application 141 and the device 110.

The first example embodiment is able to control a remote device with a simple configuration by providing a unified communication channel (pipe) ranging from an application to a device.

<Second Example Embodiment>

Next an information processing system according to a second example embodiment of the present invention will be described. The information processing system according to the second example embodiment controls a remote USB device connected to a remote communication terminal by a universal serial bus (USB) cable, from a host as an information processing device through a network, and operates the remote USB device similarly to a device connected to the host.

<<Information Processing System>>

Before describing the information processing system according to the second example embodiment, an information processing system according to an underlying technology will be described in order to clarify a feature of the second example embodiment.

(Underlying Technology)

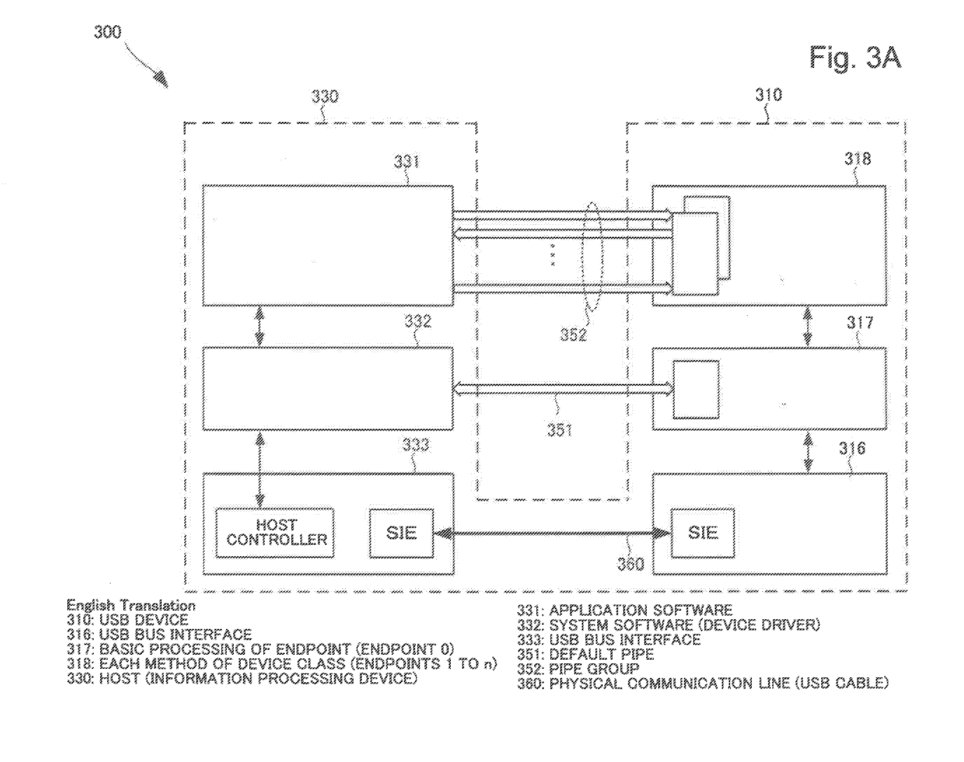

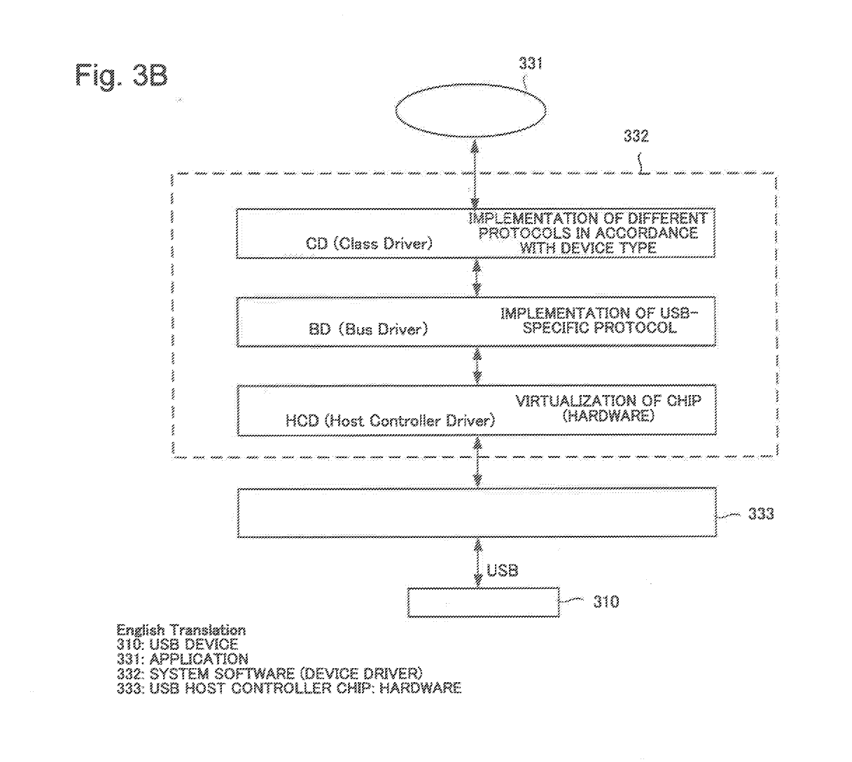

FIG. 3A is a diagram Illustrating a concept of an information processing system 300 according to the underlying technology.

The information processing system 300 includes a host 330 as an information processing device, and a USB device 310 connected to a USB connector thereon by a USB cable 360 being a physical communication line.

The host 330 includes, as software, application software 331, system software 332 as a device driven and a USB bus interface 333, The application software 331 is software for providing a service previously provided by the host 330, or a service developed by a user. The system software 332 as a device driver is loaded and activated, in accordance with such as a target device, a protocol and a data format of an input or output (below, also described to as input-output) file operation performed by the application software 331, The system software 332 interprets a command in an input-output file, and, since this example handles access to an input-output file in the USB device 310, prepares a command and a data format that conform to a USB protocol, and controls the USB bus interface 333, The USB bus interface 333 includes a host controller controlling message exchange over the USB cable 360, and a serial interface engine (SIE) controlling a signal over the USB cable 360. The USB bus interface 333 may be provided as a hardware chip.

The USB device 310 includes, as software, a USB bus interface 316 which is connected to the USB bus interface 333 in the host 330 through the USB cable 360 and exchanges a signal with the USB bus interface 333.

By such connection, the host 330 and the USB device 310 perform physical-level communication by the own USB bus interfaces 333 and 316. In a system-level control transfer, the system software 332 provides control communication as basic processing 31 using an endpoint 0 through a default pipe 351. Further, in an application-level data transfer, the application software 331 provides data communication as each method 318 of a device class using endpoints 1 to n through a pipe group 352,

FIG. 3B is a diagram illustrating a software configuration of the device driver 332 according to the underlying technology.

The device driver 332 receives an instruction for file input or output from the application software 331. The device driver 332 includes a class driver, a bus driver, and a host controller driver. The class driver implements different protocols in accordance with a variety of a target device. The bus driver implements a USB-specific protocol. The host controller driver virtualizes a hardware chip of a USB host controller 335 physically connected to the USB device 310.

<<Information Processing System according to Second Example Embodiment>>

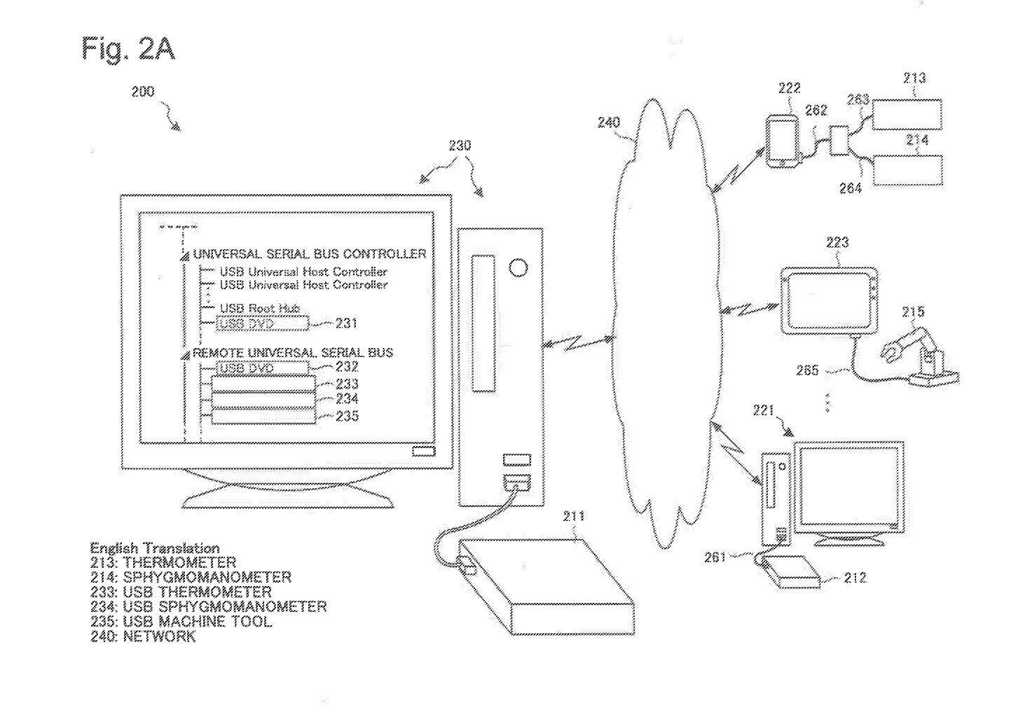

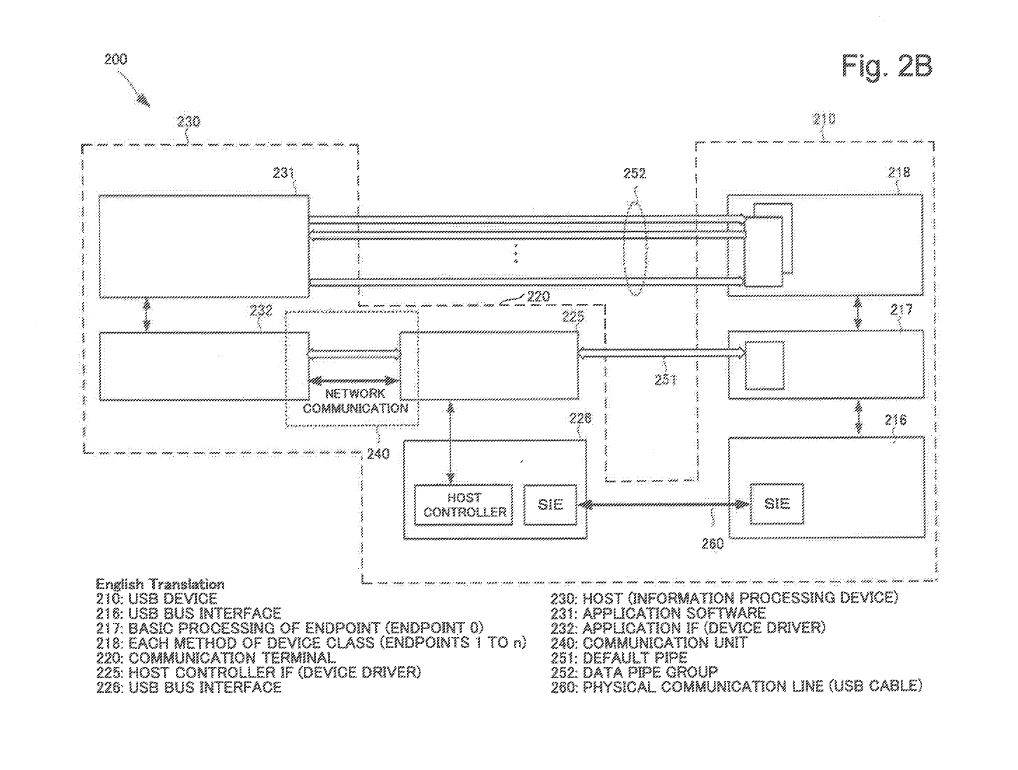

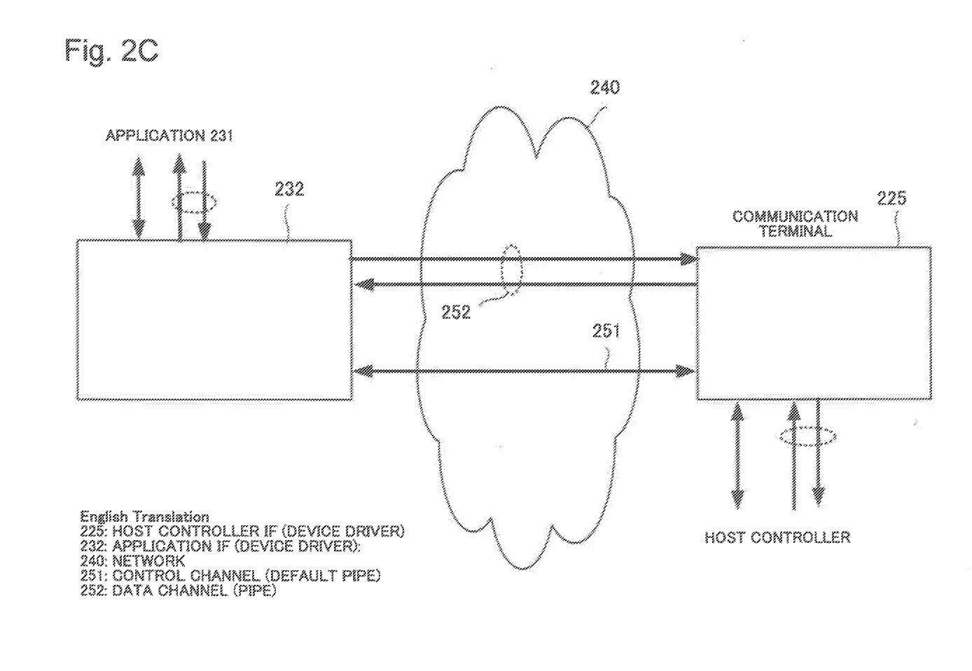

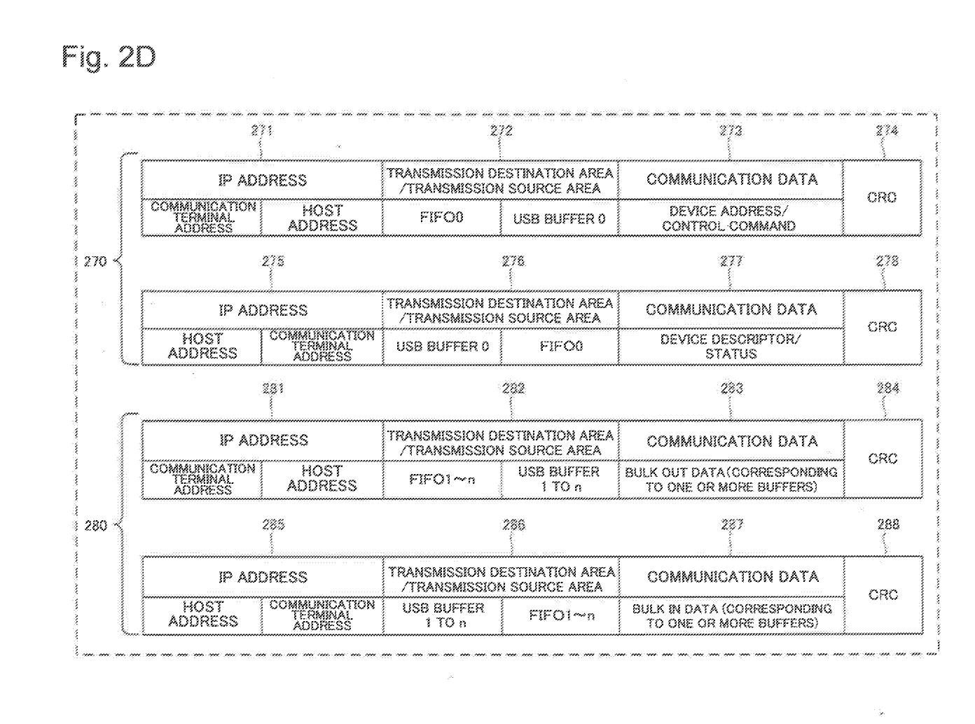

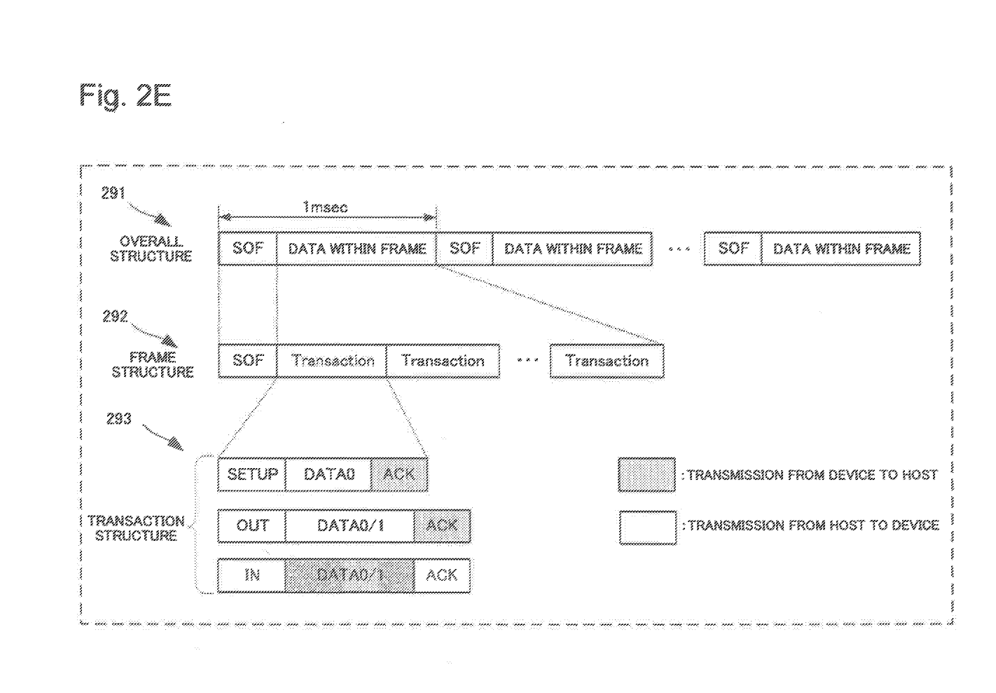

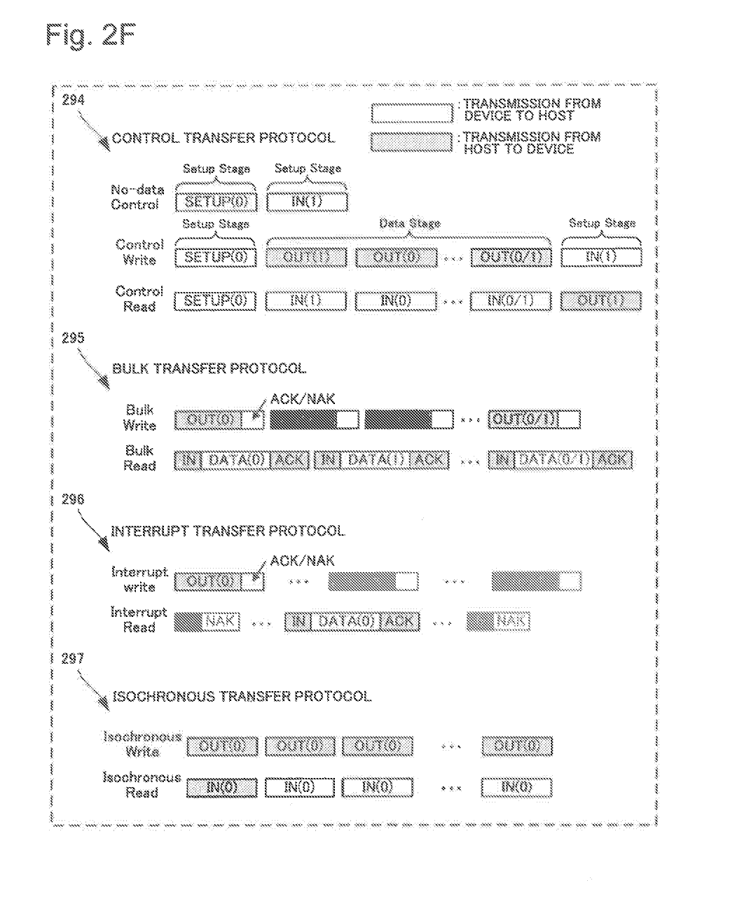

Referring to FIGS. 2A to 2f. a basic configuration and an operation of an information processing system 200 according to the second example embodiment will be described.

(System Configuration)

FIG. 2A is a block diagram illustrating a configuration of the information processing system 200 according to the second example embodiment.

The information processing system 200 includes communication terminals 221 to 223 connected to a host 230 as an information processing device through a network 240. The communication terminals 221 to 223 are connected to devices 212 to 215 through serial buses 261 to 265, respectively. The devices 213 and 214 are connected through a hub. Further, the host 230 is connected to the device 211, The devices 211 and 212 are DVD units, the device 213 is a thermometer, the device 214 is a sphygmomanometer, and the device 215 is a machine tool.

The thus connected devices are displayed as follows on a display screen of a device manager representing a device operable from the host 230, The device 211 connected to a USB connector on the host 230 is displayed as “USB DVD” 231 in an internal UNIVERSAL, SERIAL BUS CONTROLLER field. The devices 212 to 215 externally connected through the network 240 are respectively displayed in a REMOTE UNIVERSAL SERIAL BUS field as “USB DVD” 232, “USB THERMOMETER” 233, “USB SPHYGMOMANOMETER” 234, and “USB MACHINE TOOL” 235. The host 230 operates a device connected to the local device and a device remotely connected through the network 240 as same connected devices.

(System Concept)

FIG. 2B is a diagram illustrating a concept of the information processing system 200 according to the second example embodiment. Note that, in FIG. 2B, illustration of regular software such as an operating system (OS) and a basic input/output system (BIOS) is omitted.

The information processing system 200 in FIG. 2B includes the host 230 as an information processing device, a remote communication terminal 220 connected to the host 230 through the network 240, and a USB device 210 connected to a USB connector on the communication terminal 220.

The host 230 includes, as software, application software 231 and an application interface (“APPLICATION IF” in the diagram) 232 as part of a device driver. The application software 231 is software for providing a service previously provided by the host 230, or a service developed by a user. The application interface 232 interprets a structure of an input-output file operation requested by the application software 231, and generates a structure defining control information and data that are transmitted and received through the network 240, in accordance with such as a target device, a protocol and a data format of the input-output file operation. Since this example handles access to an input-output file with respect to the USB device 210, the application interface 232 prepares data transmission and reception compliant with a command and a data format that conform to a USB protocol

The communication terminal 220 includes, as software, a host controller interface (“HOST CONTROLLER IF” in the diagram) 225 as a part of a device driver, and a USB bus interface 226 including a host controller and an SIE. The host controller interface 225 passes a command, data, and the like, conforming to a USB protocol and being received from the application interface 232 through the network 240, to the host controller in the USB bus interface 226, in a format understandable to the host controller. Further, the host controller interface 225 transmits data, device status, and the like, being passed from the host controller in the USB bus interface 226, to the application interface 232 through the network 240, The host controller in the USB bus interlace 226 performs serial communication through a USB cable 260 in accordance with a USB protocol, while exchanging a command, data, and the like with the host controller interface 225. The SIE in the USB bus interface 226 controls a signal over the USB cable 260 in accordance with a USB communication specification.

The USB device 210 includes, as software, a USB bus interface 216 that is connected to the USB bus interface 226 in the communication terminal 220 through the USB cable 260 and exchanges a signal with the USB bus interface 226. Further, the USB device 210 includes an endpoint 0 217 composed of a first-in first-out (FIFO) 0 that stores a descriptor including device information and control information, and endpoints 1 to n 218 composed of FIFOs 1 to n that store input-output data.

By such connection, the communication terminal 220 and the USB device 210 perform physical-level communication by the own USB has interfaces 226 and 216. Further, by a. system-level control transfer through the application interface 232, the network 240, and the host controller interface 225, control communication as basic processing is provided between the application software 231 and the endpoint0 217 through a default pipe 251. Further, in an application-level data transfer, data communication as each method of a device class is provided between the application software 231 and the endpoints 1 to n 218 through a data pipe group 252.

As described above, a unified communication channel (pipe) can be formed by network communication between the application interface 232 in the host 230 and the host controller interface 225 in the communication terminal 220 through the network 240, and serial communication between the USB bus interfaces 226 and 216 through the USB cable.

(Remote Connection by Network)

FIG. 2C is a diagram illustrating remote connection by a network it the information processing system 200 according to the second example embodiment.

As illustrated in FIG. 2C, in network communication between the application interface 232 in the host 230 and the host controller interface 225 in the communication terminal 220 through the network 240, a control channel being the USB default pipe 251 and a data channel being the USB data pipe group 252 are established in a mutually associated manner Further, an interface between the application interface 232 and the application software 231, and an interface between the host controller interface 225 and the USB bus interface 226 in the communication terminal 220 are also associated with the USB default pipe 251 and the data pipe group 252.

(Communication Message)

FIG. 2D is a diagram illustrating a structure of a communication message according to the second example embodiment. Note that the format of the communication message is not limited to FIG. 2D.

FIG. 2D illustrates control messages 270 transmitted and received over a control channel being the default pipe 251, and data messages 280 transmitted and received over a data channel being the data pipe group 252.

Out of the control messages 270, a control message transmitted from the host 230 to the communication terminal 220 includes an IP address 271, a transmission destination area/transmission source area 272, communication data 273, and, for example, a CRC 274 for error correction. As the IP address 271, a communication terminal address of a destination and a host address of a source are set. As the transmission destination area/transmission source area 272, a FIFO 0 in the USB device 210 is designated in the transmission destination area, and a USB buffer 0 in the host 230 is designated in the transmission source area. Further, as the communication data 273, a device address assigned by the host 230 and a control command of the USB device 210 are transmitted.

Out of the control messages 270, a control message transmitted from the communication terminal 220 to the host 230 includes an IP address 275, a transmission destination area/transmission source area 276, communication data 277, and, for example, a CRC 278 for error correction. As the IP address 275, a host address of a destination and a communication terminal address of a source are sec As the transmission destination area/transmission source area 276, die USB buffer 0 in the host 230 is designated in the transmission destination area, and the FIFO 0 in the USB device 210 is designated in the transmission source area. Further, as the communication data 277, a device descriptor and device status of the USB device 210 are transmitted.

Out of the data messages 280, a data message transmitted from the host 230 to the communication terminal 220 includes an IP address 281, a transmission destination area/transmission source area 282, communication data 283, and, for example, a CRC 284 for error correction. As the IP address 281, a communication terminal address of a destination and a host address of a source are set. As the transmission destination area/transmission source area 282, FIFOs 1 to n in the USB device 210 are designated in the transmission destination area, and USB buffers 1 to n in the host 230 are designated in the transmission source area, in a mutually associated manner. Further, as the communication data 283, one or more pieces of bulk OUT data are transmitted.

Out of the data messages 280, a data message transmitted from the communication terminal 220 to the host 230 includes an IP address 285, a transmission destination area/transmission source area 286, communication data 287, and, for example, CRC 288 for error correction. As the IP address 285, a host address of a destination and a communication terminal address of a source are set. As the transmission destination area/transmission source area 286, USB buffers 1 to n in the host 230 are designated in the transmission destination area., and FIFOs 1 to n in the USB device 210 are designated in the transmission source area, in a mutually associated manner. Further, as the communication data 287, one or more pieces of bulk IN data are transmitted.

While other transfer types include an interrupt transfer and an isochronous transfer, in addition to the control transfer and the bulk transfer, the other transfer types include similar data message structures except that the “SETUP” stage is omitted, and therefore description of the messages thereof is omitted.

While network communication is performed between the host 230 and the communication terminal 220 in terms of encapsulated IP addresses, data are transmitted between a USB buffer secured in the host 230 by the application software 231, and a FIFO being an endpoint in the USB device 210.

(USB Transfer Format and Protocol)

FIG. 2E is a diagram illustrating a format of USB transfer data according to the second example embodiment.

An overall structure 291 is composed of a plurality of frames, each frame starting from a Start of Frame (SOF) and including a transaction group being transactions grouped together, normally communicated at 1 millisecond intervals. In FIG. 2D, a content communicated as communication data may be one frame or a plurality of frames. In this case, in the host computer 230, a transaction group is generated by a. macro program (function) corresponding to each USB device 210, and is communicated to the communication terminal 220. Meanwhile, the communication terminal 220 convers from a frame to a transaction and further to a packet, and exchanges data with the USB device 210.

Each frame structure 292 is composed of a plurality of transaction groups, each group starting from an SOF. A transaction configuration 293 includes three transmission and reception units, “SETUP”, “OUT”, and “IN”. Further, a packet being a minimum unit of communication constituting each transaction is serially communicated through the USB cable 260. In FIG. 2E, shaded data represent data transmitted from a device to a host computer, and unshaded data represent data transmitted from the host computer to the device. In FIG. 2D, a content communicated as communication data may be a plurality of transactions or per transaction. In this case, in the host computer 230, a transaction is generated by a program, (function) for each transaction corresponding to each USB device 210, and is communicated to the communication terminal 220. The communication terminal 220 convers from a transaction to a packet and exchanges data, with the USB device 210.

FIG. 2F is a diagram illustrating a USB logical protocol according to the second example embodiment.

A control transfer protocol 294 is a protocol transferring a control command and a device descriptor as control data so as to generate the bidirectional default pipe 251 in FIG. 2B. The control transfer protocol 294 includes “No-data Control” not including transfer data, “Control Write” transmitting a control command to a device, and “Control Read” receiving a device descriptor and the like from the device.

A bulk transfer protocol 295 is a protocol asynchronously transferring a large amount of data so as to generate the unidirectional data pipe group 252 in FIG. 2B. The bulk transfer protocol 295 includes “Bulk Write” transmitting data to a device and “Bulk Read” receiving data from the device.

An interrupt transfer protocol 296 is a protocol transferring data apparently in accordance with notification from a device, by the device responding at any timing to periodic polling from a host computer, so as to generate the unidirectional data pipe group 252 in FIG. 2B, The interrupt transfer is used for data transfer when an amount of the data is small and a generation timing thereof is undetermined. The interrupt transfer protocol 296 includes “Interrupt Write” transmitting data to the device and “Interrupt Read” receiving data from the device.

An isochronous transfer protocol 297 is a protocol performing periodic data transfer so as to generate the unidirectional data pipe group 252 in FIG. 2B. The isochronous transfer protocol 292 attaches more importance to time than data reliability, and does not perform retransmission due to an error. The protocol is used for data transfer of voice, a video image of a CCD camera, and the like. The isochronous transfer protocol 297 includes “Isochronous Write” transmitting data to a device and “Isochronous Read” receiving data from the device.

Each transfer protocol in FIG. 2F may be associated with a frame in FIG. 2E, or a plurality of transfer protocols may be grouped together to form a frame. In either case, various types of logical layer (L2) communication between the application interface 232 and the host controller interface that constitute a device driver can be provided, by format negotiation between the host computer 230 side and the communication terminal 220 side.

<<Functional Configuration of information Processing Device>>

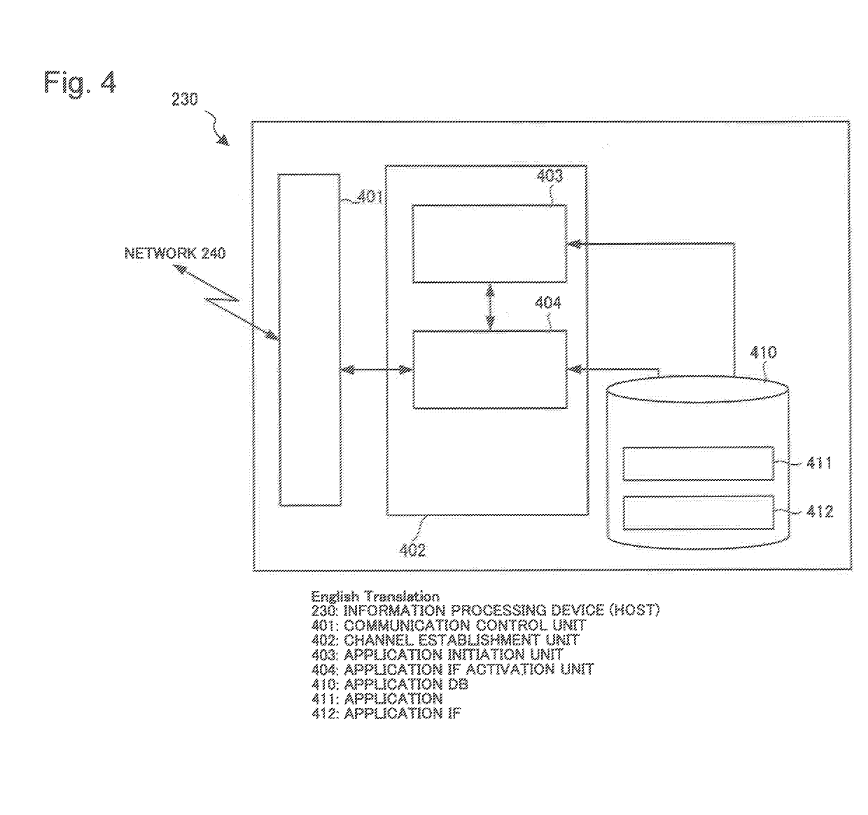

FIG. 4 is a block diagram illustrating a functional configuration of the information processing device 230 according to the second example embodiment. Note that, in FIG. 4, functional components deeply related to an operation according to the second example embodiment are illustrated, and a regular functional component included in the information processing device 230 is not illustrated. For example, various types of processing functions in a case that the information processing device 230 is a personal computer (hereinafter PC) are not illustrated.

The information processing device 230 includes a communication control unit 401, a channel establishment unit 402, and an application database (APPLICATION DB in the diagram) 410. The communication control unit 401 controls communication with the communication terminal 220 through the network 240, The channel establishment unit 402 includes an application initiation unit 403 and an application interface activation unit 404, and establishes a channel between the information processing device 230 and the communication terminal 220, and further, the USB device 210. The application database 410 stores a plurality of applications 411 and a plurality of application interfaces 412 being part of a device driver.

The application initiation unit 403 selects an application from the application database 410 and initiates the application, in order to provide a service to a user. The application interface activation unit 404 searches the application database 410 for an application interface for providing an input-output file operation instructed by an application initiated by the application initiation unit 403, and activates the operation.

<<Functional Configuration of Communication Terminal>>

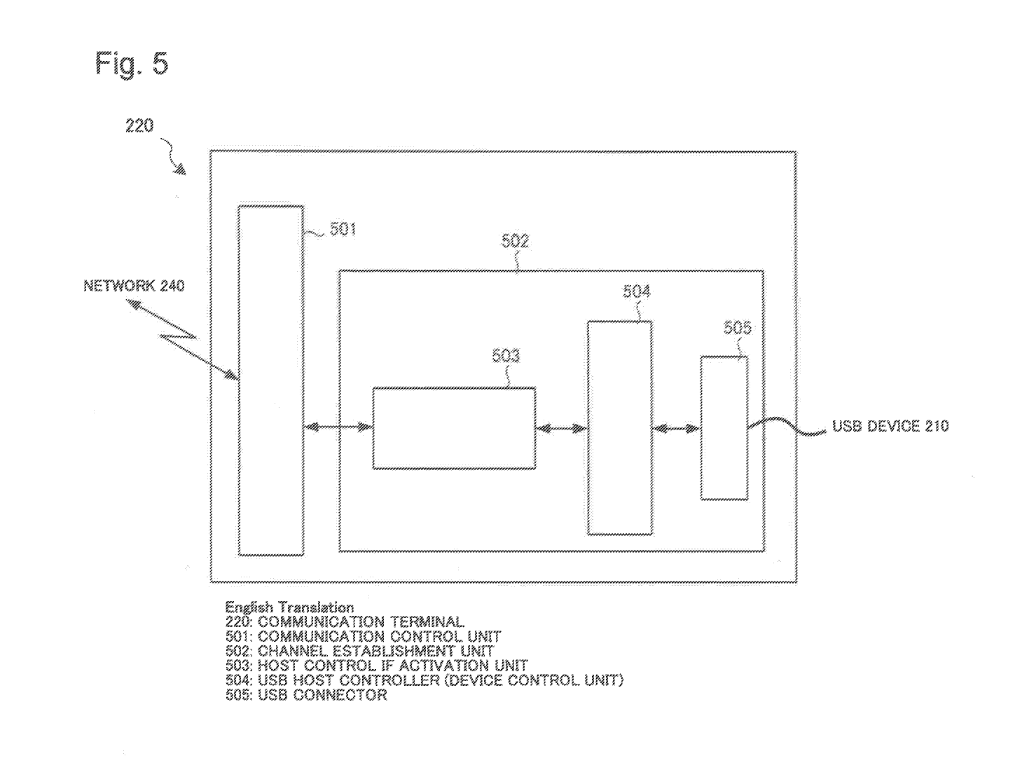

FIG. 5 is a block diagram illustrating a functional configuration of the communication terminal 220 according to the second example embodiment. Note that, in FIG. 5, functional components deeply related to an operation according to the second example embodiment are illustrated, and a regular functional component included in the communication terminal 220 is not illustrated. For example, various types of processing functions in a case that the communication terminal 220 is a smartphone or a tablet are not illustrated.

The communication terminal 220 includes a communication control unit 501 and a channel establishment unit 502. The communication control unit 501 controls communication with the information processing device 230 through the network 240. The channel establishment unit 502 includes a host control interface activation unit 503, a USB host controller 504 as a device control unit, and a USB connector 505 including an SIE. The host control interface activation unit 503 activates a host controller interface that interfaces with the USB host controller 504 being part of a device driver, in response to an input-output file operation. The USB host controller 504 controls packet switching by the USB bus interface 226, in order to provide an input-output file operation instructed by an application initiated by the application initiation unit 403. The USB connector 505 is connected to the USB cable for packet switching with the USB device 210.

(Information Flow)

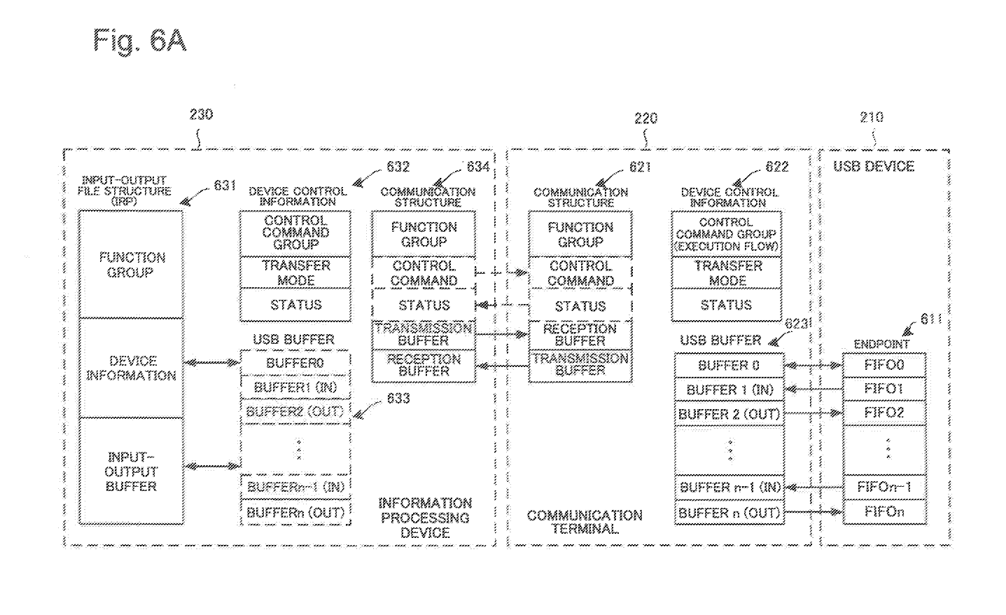

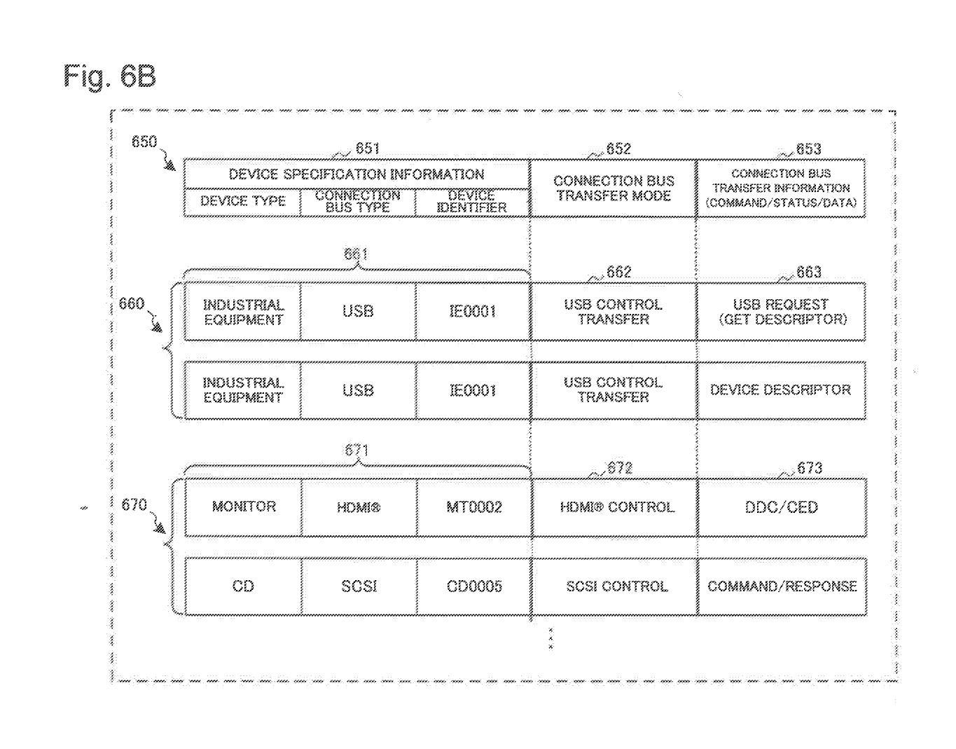

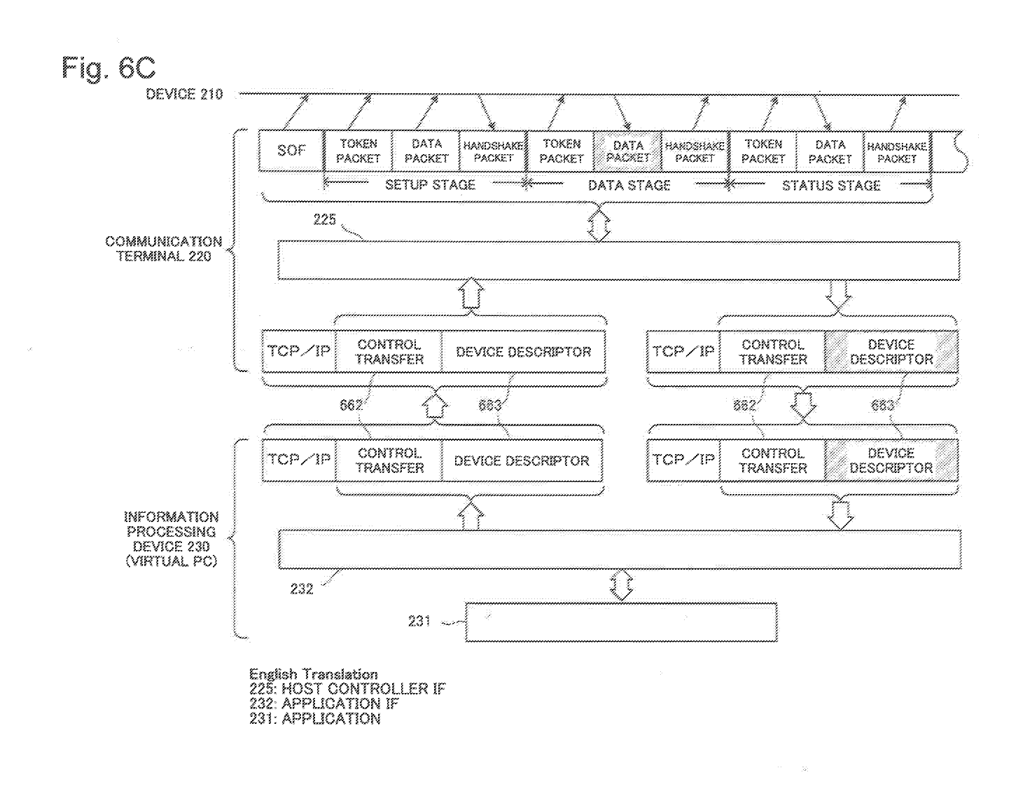

FIG. 6A is a diagram illustrating an information flow in the information processing system 200 according to the second example embodiment. Note that FIG. 6A illustrates main storage areas, and a detailed configuration is omitted. FIG. 6A illustrates an example that processing of a host controller driver in a device driver is separated between the information processing device 230 as a host and the remote communication terminal 220 through communication, so that the information processing device 230 apparently controls the USB device 210 through direct connection. However, it is desirable to select a layer in which the device driver is separated, in accordance with performance of the information processing device 230 and the communication terminal 220, and a communication environment.

An input-output file structure 63b a USB buffer 633 and a communication structure 634 are secured in the information processing device 230, The input-output file structure 631 is secured when the application software 231 instructs an input-output file operation and, for example, includes a function group performing predetermined processing in accordance with a file storage destination, a device type, an input-output protocol, and the like, device information, and an input-output buffer. Device control information 632 includes a transmitted and received control command group, a current transfer mode, and status. The control command group includes control commands for controlling a setting related to communication, an action against a communication error, and the like, in addition to control commands for controlling input and output from and to the USB device. The device control information 632 may be integrated into the device information in the input-output file structure 631. The USB buffer 633 includes a buffer corresponding to each endpoint secured by the application interface 232 in accordance with processing by the function group in the input-output file structure 631, when a device type is a USB device. The communication structure 634 is a structure secured by the application interface 232 in accordance with processing by the function group in the input-output file structure 631. when a device is at a remote location through the network. The communication structure 634 includes a function group for setting a protocol and a message format that are related to communication, a communication rate, and the like, a control command to be transmitted, received status, a transmission buffer temporarily storing transmitted data, and a reception buffer temporarily storing received data. The USB buffer 633 Is optional. Data transfer may be directly performed between the input-output buffer in the input-output file structure 631, and the transmission buffer and the reception buffer in the communication structure 633. Further, when a layer in which the device driver is separated by communication is higher, a control command and status need not be communicated independently, and may be included in transmitted and received data.

A communication structure 621, device control information 622, and a USB buffer 623 are secured in the communication terminal 220. The communication structure 621 is a structure associated with the communication structure 634 secured by the application interface 232. The communication structure 621 includes a function group for setting a protocol and a message format related to communication, a communication rate, and the like, a received control command, status to be transmitted, a reception buffer temporarily storing received data, and a transmission buffer temporarily storing transmitted data. The device control information 622 includes a transmitted and received control command group, a current transfer mode, and status. Each control command in the control command group is associated with a control flow convening the control command into a USB command string executing the control command. Further, the control command group includes control commands for controlling a setting related to communication, an action against a communication error, and the like, in addition to control commands for controlling input and output from and to the USB device. The USB buffer 623 includes a buffer secured when a device type is a USB device, corresponding to each endpoint in the USB device 210.

FIFOs 0 to n are prepared in the USB device 210 as endpoints 611, in accordance with a device type.

(Communication Data Structure Example)

FIG. 6B is a diagram illustrating a communication data structure in the information processing system 200 according to the second example embodiment. Note that, in FIG. 6B, an IF address for encapsulation and the like in FIG. 2D are omitted. While FIG. 6B illustrates an example of a communication data structure providing the second example embodiment, the structure is not limited thereto. For example, as communication data in an upper layer of a device driver, a parameter (argument) of a function may be transmitted and received, or the function itself may be transmitted and received.

FIG. 6B illustrates a basic communication data structure 650, a communication data structure 660 in a case of USB, and a communication data structure 670 in a case of other interlace types being the High-Definition Multimedia Interface (HDMI)® and the small computer system interface (SCSI).

The communication data structure 650 includes device specification information 651. The device specification information 651 includes a device type, a connection bus type, and a device identifier. The communication data structure 650 includes a transfer mode 652 over a connection bus and information 653 to be transferred through the connection bus. The information 653 to be transferred includes a command, status, and data.

The communication data structure 660 in a case of USB includes industrial equipment being the device type, USB being the connection bus, and IE 001 being the device identifier, as device specification information 661. The communication data structure 660 in the case of USB includes a USB control transfer as a transfer mode 662, and a USB request or a device descriptor as transfer information 663. Such a structure eliminates the need to consider a limitation of a maximum number of 127 in conventional USB connection.

The communication data structure 670 in a case of other interface types being HDMI® and SCSI includes a monitor, HDMI®, MT 0002, and a CD, SCSI, and CD 0005 as device specification information 671. Further, the structure includes HDMI® control and SCSI control as a transfer mode 672, and DDC/CED and command/response as transfer information 673.

(Data Transmission Example)

FIG. 6C is a diagram illustrating, data transmission in the information processing system according to the second example embodiment. While FIG. 6C illustrates L2-level communication at the USB device, the communication may be performed in a lower layer or a higher layer. FIG. 6C is a diagram illustrating a descriptor acquisition procedure of a USB-connected USB device.

A descriptor set to the device 210 is acquired by a USB request 663 such as GET DESCRIPTOR, Each USB request 663 is exchanged with the device 210 by a control transfer 662. Each control transfer 662 includes a setup stage, a data stage, and a status stage. Each stage is composed of a token packet, a data packet, and a handshake packet. A descriptor is acquired in a data packet in each data stage. A descriptor acquired from the device 210 is IP encapsulated by an IP header and a TCP header, and is transmitted from the mobile terminal 220 to the information processing device 230.

In response to a device input-output request by the application 231, the application interface 232 in the information processing device 230 first generates a control transfer 662 and a USB request 663 (GET DESCRIPTOR) in order to cheek a connected device, and supplies the control transfer 662 and the USB request 663 to the communication control unit 401.

The control transfer 662 and the USB request 663 (GET DESCRIPTOR) that are IP encapsulated by an IP header and a TCP header are received by the communication control unit 501 in the communication terminal 220, and are IP descapsulated. The control transfer 662 and the USB request 663 (GET DESCRIPTOR) are supplied to the host controller interface 225, The host controller interface 225 instructs the USB bus interface 226 (unillustrated in FIG. 6C) to generate each packet to the device 210 over the USB bus, in accordance with the control transfer 662 and the USB request 663 (GET DESCRIPTOR).

The host controller interface 225 extracts a data packet received from the device 210 in a data stage as a device descriptor, and supplies the data packet to the communication control unit 501 as a control transfer 662 and a device descriptor 663. The control transfer 662 and the device descriptor 663 that are IP encapsulated by an IP header and a TCP header are transmitted from the communication control unit 501 in the communication terminal 220 to the communication control unit 401 in the information processing device 230.

When the communication control unit 401 in the information processing device supplies the encapsulated control transfer 662 and the decapsulated device descriptor 663 to the application interface 232, the application interface 232 notifies connected device information in response to the device input-output request by the application 231.

Similar data transmission is subsequently performed in another control transfer, a bulk transfer, an interrupt transfer, and an isochronous transfer The host controller interface 225 and the USB bus interface 226 may be integrated into one piece of software.

(Operation Procedure.)

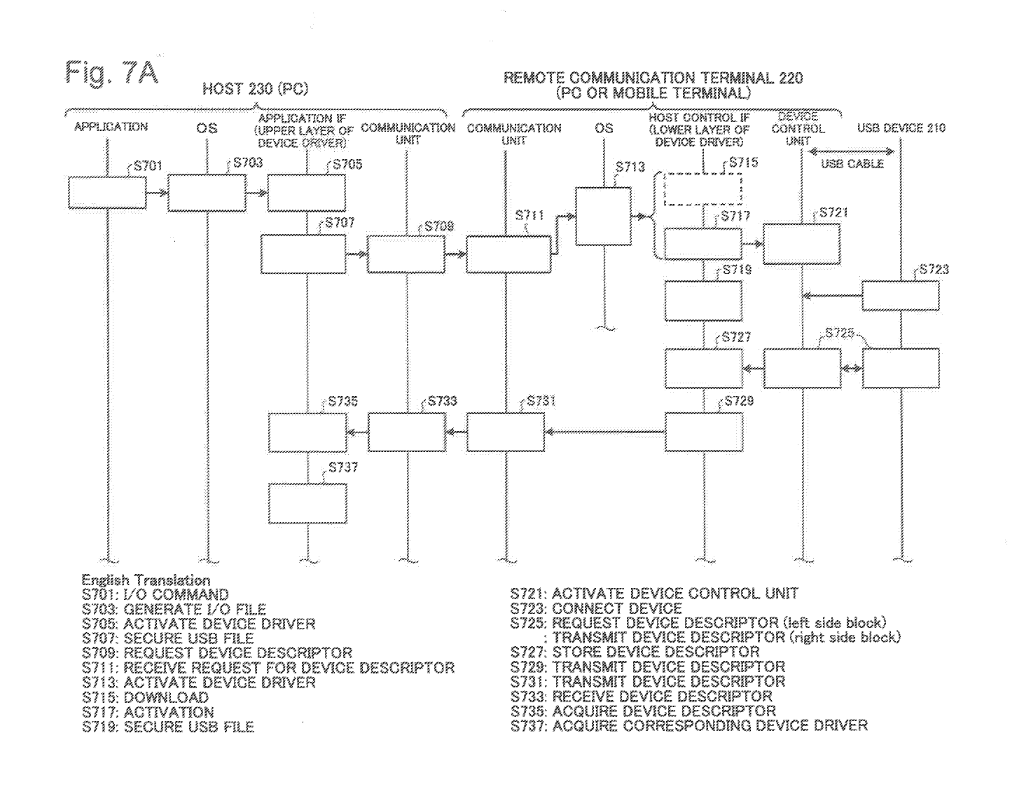

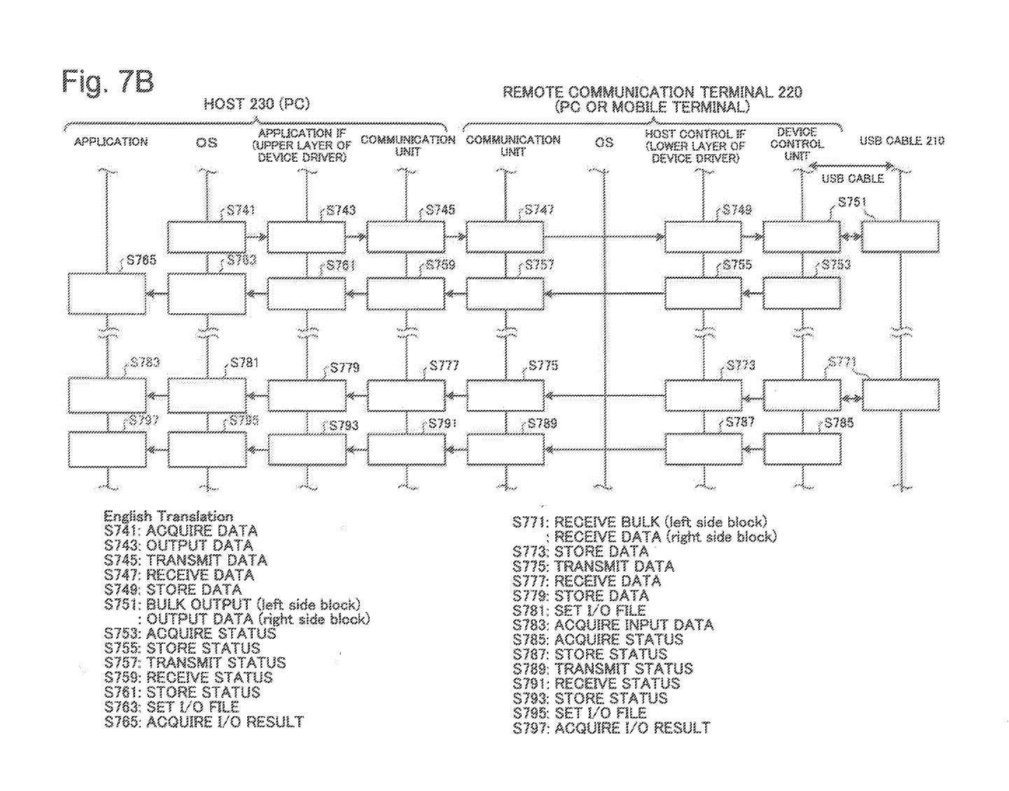

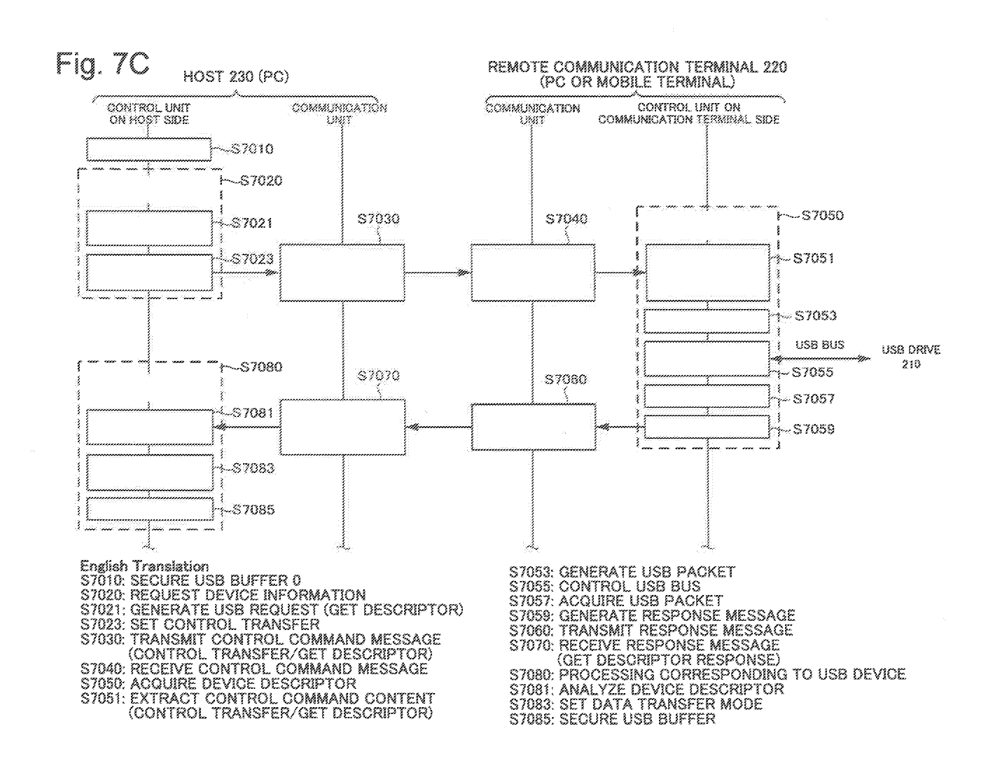

FIGS. 7A to 7C are sequence diagrams illustrating an operation procedure of the information processing system 200 according to the second example embodiment. While an OS is actually involved in various types of processing in the sequences in FIGS. 7A to 7C, illustration thereof is limited to a minimum. Further, while Figs, 7A to 7C illustrate an example that the host 230 initiates processing, processing can be initiated front the USB device side even in a case of USB-based device connection, according to the second example embodiment.

FIG. 7A is an operation procedure of the host 230 acquiring a device descriptor of the USB device 210, and searching for and acquiring a device driver corresponding to the USB device 210, as an initial operation. FIG. 7A illustrates an example that the host 230 initiates acquisition of a device descriptor. By contrast, when acquisition of a device descriptor is triggered by connection of the USB device 210 to a USB connector on the communication terminal 220, the connection of the USB device 210 is notified to the host 230.

In Step S701, it is assumed that an application generates an I/O command. In Step S703, the OS receiving the I/O command creates an I/O file being an input-output file structure. Then, in Step S705, as application interface being an upper layer of a device driver is activated. In Step S707, the application interface secures a USB file. Then, in Step S709, the application interface requests a device descriptor through the communication unit in the host 230.

Whet the communication unit in the communication terminal 220 receives the request for a device descriptor in Step S711 the OS activates a host control interface being a lower layer of the device driver in Step S713. The communication terminal 220 may download a host controller interface as needed in Step S715 and activate the host controller interface in Step S717. Then, in Step S719, the host controller interface secures a USB file. In Step S721, the activated host controller interface activates a USB host controller as a device control unit. In Step S715, the host controller interface may be delivered from the host 230 or delivered from another server.

When the USB device 210 is connected to the communication terminal 220 by a USB cable in Step S723, a device descriptor stored in the FIFO0 is requested, and the USB device 210 transmits the device descriptor, in Step S725. In Step S727, the device descriptor is temporarily stored in a USB buffer secured by the communication terminal 220. Then, in Step S729, the host controller interface instructs the communication unit to transmit the device descriptor to the host 230. In Step S731, the communication unit transmits the device descriptor acquired from the USB device 210 to the host 230.

In Step S733, the communication unit in the host 230 receives the device descriptor and passes the device descriptor to the application interface in Step S735. The application interface acquires the device descriptor and acquires a corresponding device descriptor in accordance with the USB device type.

FIG. 7B is an operation procedure of outputting data from the host 230 to the USB device 210, and an operation procedure of the host 230 inputting data from the USB device 210. It is assumed that an operation of data output to the USB device 210 or data Input from the USB device 210 is already instructed by the application software 231, and preparation is completed in the host 230, the communication terminal 220, and the USB device 210.

In Step S741 in the operation procedure of outputting data from the host 230 to the USB device 210, the OS on the host 230 receives a request from an application, acquires data to be output to the USB device 210, and temporarily stores the data into a USB buffer. In Step S743, in order to output the acquired data to the remote USB device 210, the application interface instructs output to the communication unit in the host 230. The communication unit encapsulates the data in the USB buffer and transmits the data to the communication terminal 220 connected to the USB device 210. An amount of output data to be encapsulated is not limited by a data amount of bulk output, and a plurality of units of bulk output data may be transmitted in one packet.

In Step S747, the communication unit in the communication terminal 220 receives the output data transmitted from the communication unit in the host 230. In Step S749, the host controller interface decapsulates the output data received by the communication unit and temporarily stores the data into a corresponding USB buffer. Then, the host controller interface instructs the USB bus interface 226 as a device control unit to transmit the data to the USB device 210. In Step S751, the USB bus interface 226 receiving the output instruction from the host controller interface outputs bulk of the data in the USB buffer to a corresponding FIFO (endpoint) in the USB device 210. Thus, output to the USB device 210 is performed in accordance with an output file operation by the application in the host 230.

In Step S753, during the bulk output to the USB device 210 or on completion of the bulk output, the USB bus interface 226 acquires status of the USB device 210. In Step S755, the host controller interface temporarily stores the status of the USB device 210 into the USB buffer 0. Then, the host controller interface instructs the communication unit to transmit the status of the USB device 210 to the host 230. In Step S757, the communication unit in the communication terminal 220 encapsulates the status data in the USB buffer 0 and transmits the status data to the host 230.

In Step S759, the communication unit in the host 230 receives the status data transmitted from the communication unit in the communication terminal 220. In Step S761, the application interface decapsulates the status data received by the communication unit, and temporarily stores the status data into the USB buffer 0. Then, the host controller interface instructs the OS to write the status data into the input-output file structure. In Step S763, the OS sets the status data to an I/O file as an input-output buffer structure. In Step S765, the application software 231 acquires the result of the output operation by referring to the input-output file structure.

In Step S771 in the operation procedure of inputting data to the host 230 from the USB device 210, the USB bus interface 226 receiving au input instruction from the host controller interface receives bulk from a corresponding FIFO (endpoint) in the USB device 210. In Step S773, the host controller interface temporarily stores input data from the USB device 210 into a corresponding USB buffer. Then, the host controller interface instructs the communication unit to transmit the input data to the host 230. In Step S775, the communication unit in the communication terminal 220 encapsulates the input data in the USB buffer and transmits the input data to the host 230. An amount of Input data to be encapsulated is not limited by a data amount of bulk input, and a plurality of units of bulk input data may be transmitted in one packet.

In Step S777, the communication unit in the host 230 receives the input data transmitted from the communication unit in the communication terminal 220. In Step S779, die application interface encapsulates the input data received by the communication unit and temporarily stores the input data into a corresponding USB buffer. Then, the host controller interface instructs the OS to write the input data into the input-output file structure. In Step S781, the OS sets the input data to an I/O file as an input-output buffer structure. In Step S783, the application software 231 acquires from the input-output file structure the input data, input of which is instructed by the application software 231.

In Step S785, during the bulk input to the USB device 210 or on completion of the bulk input, the USB bus interface 226 acquires status of the USB device 210. Subsequent processing of the application software 231 acquiring the result of the input operation by referring to the input-output file structure, up to Step S797, is similar to Steps S755 to S765 in the output operation, and therefore detailed description thereof is omitted.

FIG. 7C is a sequence diagram illustrating a detailed communication procedure between request and acquisition of a device descriptor in FIG. 7A. While FIG. 7C illustrates part of the procedure in FIG. 7A in detail, the other part of the processing in FIG. 7A and the processing in FIG. 7B am also processed as illustrated in FIG. 7C. In FIG. 7C, control performed by a unit other than the communication unit is consolidated in the control unit on the host side and the control unit on the communication terminal side.

In Step S7010, the control unit on the host side in the host 230 secures the USB buffer 0, Next, in Step S7020, the control unit on the host side requests device information to the USB device. Step S7020 includes Step S7021 in which “GET DESCRIPTOR” as a USB request is generated and Step S7023 in which a control transfer protocol is set. In Step S7030, the communication unit transmits a message including a control command to the communication terminal 220. The message includes an indication of a control transfer and GET DESCRIPTOR.

In Step S7040. the communication unit in the communication terminal 220 receives the message including the control command from the host 230. Next, in Step S7050, the control unit on the communication terminal side acquires a device descriptor from the USB device 210. Step S7050 includes Steps S7051 to S7059. In Step S7051, a content of the control command is extracted from the received message. In Step S7053, a USB packet for providing the content of the control command is generated. In Step S7055, USB bus for acquiring a device descriptor is controlled. In Step S7057, a USB packet including a device descriptor is acquired. Then, in Step S7059, a response message including die acquired device descriptor is generated. In Step S7060, the communication unit in the communication terminal 220 transmits the generated response message to the host 230.

In Step S7070, the communication unit in the host 230 receives the response message from the communication terminal 220. The response message includes the device descriptor of the USB device 210. In Step S7080, the control unit on the host side analyses the device descriptor and performs processing (preparation of input and output) corresponding to the USB device 210. Step S7080 includes Steps S7081, S7083, and S7085. In Step S7081, the received device descriptor is analyzed. In Step S7083, a data transfer mode corresponding to the USB device 210 is set. In Step S7085, a required USB buffer corresponding to the USB device 210 other than the USB buffer 0 is secured.

Data input and output is subsequently performed after going through setting to the USB device 210. FIG. 7C illustrates an example that processing of a host controller driver in a device driver is separated between the information processing device 230 as a host and the remote communication terminal 220 through communication, so that the information processing device 230 apparently controls the USB device 210 through direct connection. However, it is desirable to select a layer in which the device driver is separated, in accordance with performance of the information processing device 230 and the communication terminal 220, and a communication environment.

<<Hardware Configuration of Information Processing Device>>

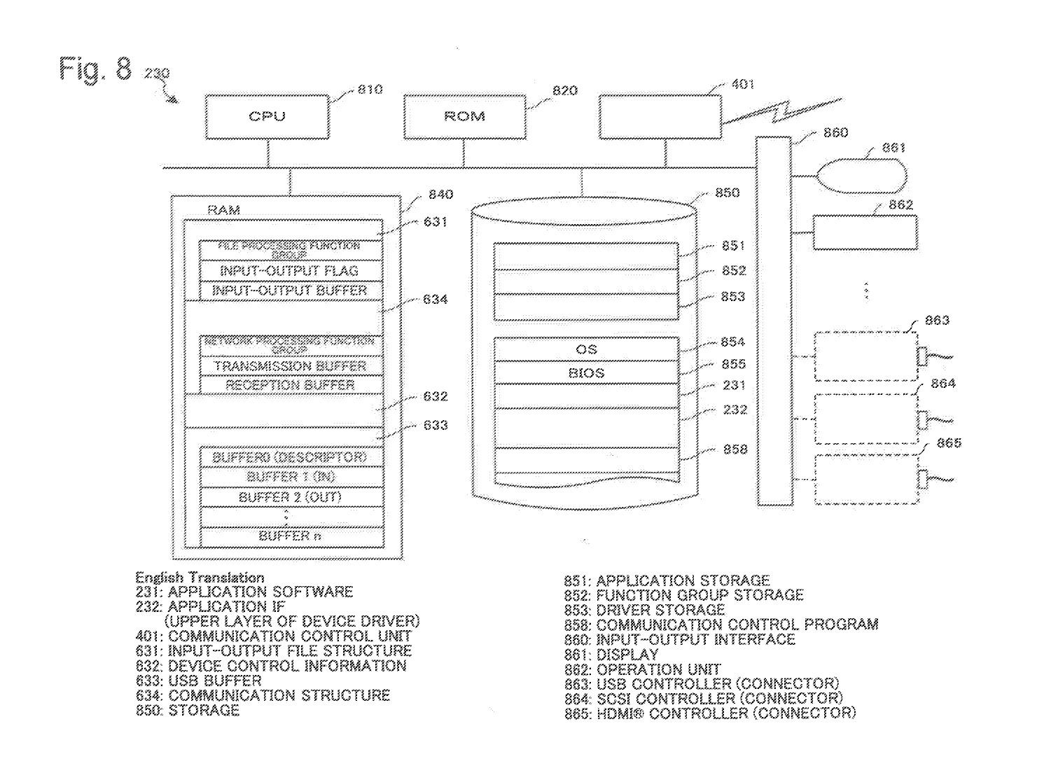

FIG. 8 is a block diagram illustrating a hardware configuration of the information processing device 230 according to the second example embodiment.

In FIG. 8f a central processing unit (CPU) 810 is a processor for arithmetic control, and provides the functional components in the information processing device 230 in FIG. 4 by executing a program. A read only memory (ROM) 820 stores initial data, fixed data for a program and the like, and a program. The communication control unit 401 communicates with the communication terminal 220 through the network 240. Further, the CPU 810 is not limited to a single CPU, and may include a plurality of CPUs or a graphic processing unit (GPU) for image processing. Further, it is desirable that the communication control unit 401 include a CPU independent of the CPU 810, and write or read transmitted and received data into or from a random access memory (RAM) 840. Further it is desirable that a direct memory access controller (DMAC) (unillustrated) transferring data between the RAM 840 and a storage 850 be provided. Additionally, it is desirable that an input-output interface 860 include a CPU independent of the CPU 810, and write or read input-output data into or from the RAM 840. Accordingly, the CPU 810 processes data, recognizing that data are received by or transferred to the RAM 840. Further, the CPU 810 prepares the processing result in the RAM 840 and delegates subsequent transmission or transfer to the communication control unit 401, the DMAC, or the input-output interlace 860.

The RAM 840 is a random access memory used by the CPU 810 as a work area for temporary storage. An area for storing data required for providing the second example embodiment is secured in the RAM 840. The input-output file structure 631 is a structure created by the OS in response to an input-output file operation by the application software 231. The input-output file structure 631 includes areas for a file processing function group, an input-output flag, and an input-output buffer. The communication structure 634 is a structure for the application interface 232 to pass communication control by a communication control program 858. The communication structure 634 includes areas for a network processing function group, a transmission buffer, and a reception buffer. The device control information 632 includes a control command group, a transfer mode, and status, for controlling a device. The USB buffer 633 is a buffer associated with a FIFO (endpoint) in the USB device 210, and includes a buffer 0 for control data and buffers 1 to n for data, in accordance with a type of the USB device 210, and input-output processing. The USB buffer 633 is an optional component, and data exchange may be directly performed between the input-output file structure 631 and the communication structure 634.

The storage 850 stores a database, various types of parameters, or the following data or programs required for providing the second example embodiment. An application storage 851 stores application software provided by the information processing device 230 in a searchable manner. A function group storage 852 stores a function used by the information processing device 230 in a searchable manner. A driver storage 853 stores a device driver, an application interface being part of the device driver, and the like in a searchable manner.

The storage 850 stores the following programs. An OS 854 is a basic program controlling the entire information processing device 230. A BIOS 855 is a basic program controlling an input-output operation of die information processing device 230. The application software 231 is an application program currently under execution by the information processing device 230. The application interface 232 is a program providing an interface with the application software 231 as part of a device driven A communication control program 858 is a program performing communication with the communication terminal 220 by the communication control unit 401.

The input-output interface 860 provides an interface for input-output data from and to input-output equipment. The input-output interface 860 is connected to a display 861 and an operation unit 862. Further, when a device can be used through direct connection to the information processing device 230 by a serial bus cable, a USB controller (connector) 863, a SCSI controller (connector) 864, an HDMI® controller (connector) 865, and the like may be connected. Additionally, a speaker being an audio output unit, a microphone being an audio input unit, or a GPS position determination unit may be connected.

Note that a program and data related to a general-purpose function and another performable function, being implemented on the information processing device 230, are not illustrated in the RAM 840 and the storage 850 in FIG. 8.

<<Processing Procedure of Information Processing Device>>

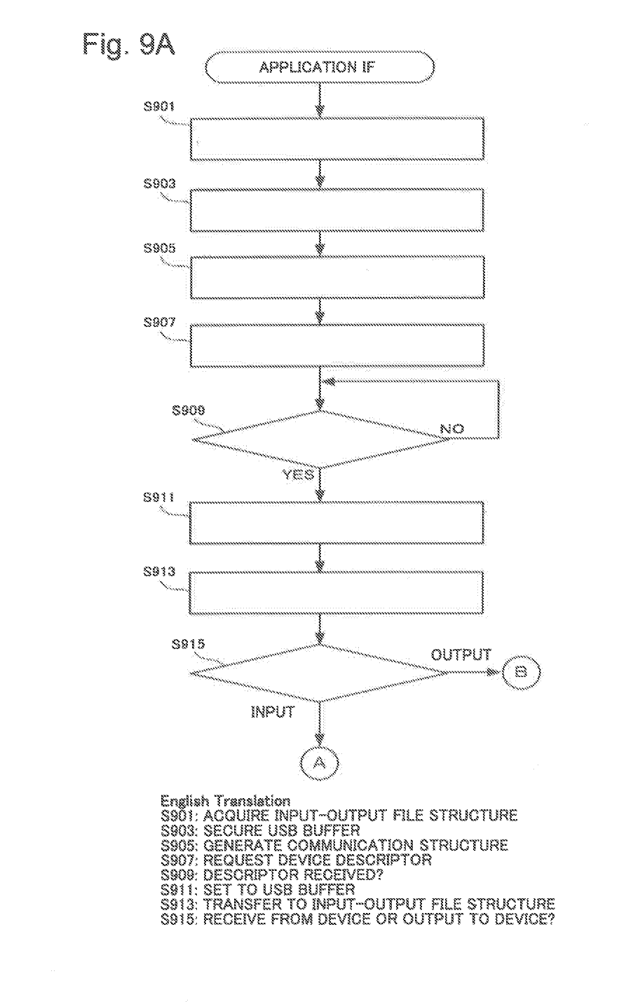

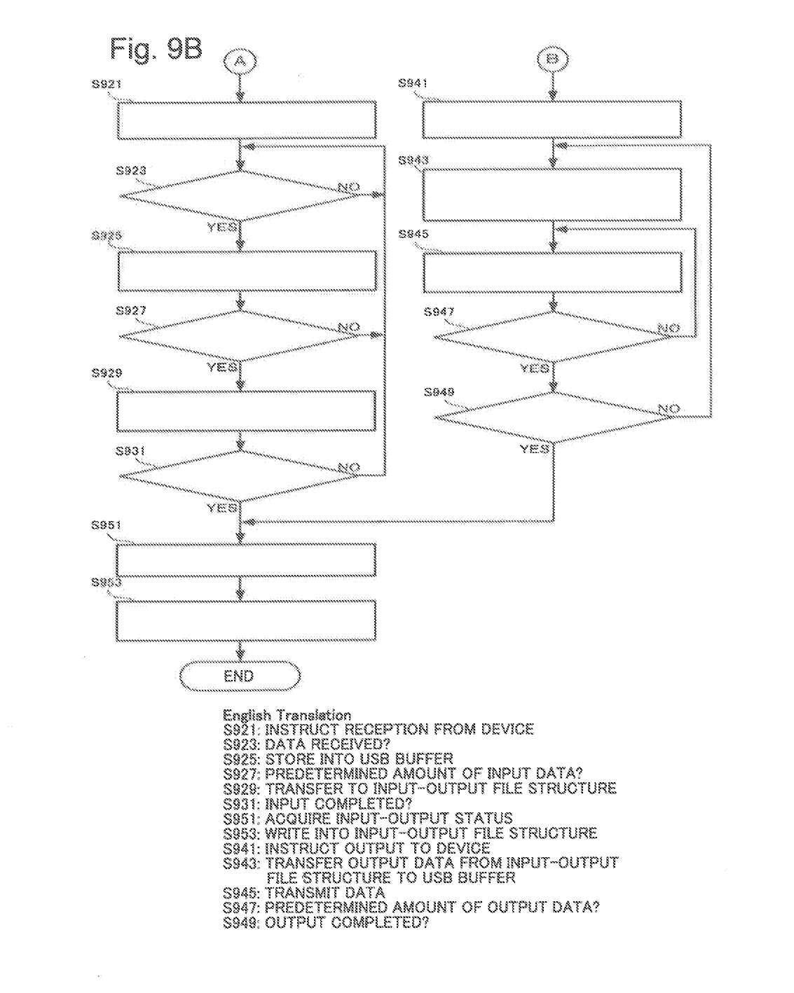

FIGS. 9A and 9B are flowcharts illustrating a processing procedure of the information processing device 230 according to the second example embodiment. The CPU 810 in FIG. 8 executes the flowcharts using the RAM 840 to provide the functional components in FIG. 4. In FIGS. 9A and 9B, a processing procedure by the application interface 232 will be described.

In Step S901, the information processing device 230 acquires an input-output file structure passed from the application software 231. In Step S903, the information processing device 230 refers to the input-output file structure and secures a USB buffer In Step S905, the information processing device 230 refers to die input-output file structure and generates a communication structure. In Step S907, the information processing device 230 requests a device descriptor of the USB device 210. Then, in Step S909, the information processing device 230 awaits receipt of the device descriptor of the USB device 210.

Upon receipt of the device descriptor of the USB device 210, in Step S911, the information processing device 230 sets the received device descriptor to the secured USB buffer 0. Then, in Step S913, the information processing device 230 transfers the received device descriptor to the input-output file structure. Analysis of the received device descriptor is performed by the OS, the BIOS, the application interface 232, the application software 231, or cooperation therebetween. Next, in Step S915, the information processing device 230 determines from the input-output file structure whether the processing to be performed is reception processing from the USB device 210 or output processing to the USB device 210.

In a case of reception processing from the USB device 210, in Step S921, the information processing device 230 instructs reception processing from the USB device 210, In this example, the communication structure is used, and the instruction is conveyed to the USB device 210 through the host controller interface 225 in die communication terminal 220, In Step S923, the information processing device 230 awaits receipt of input data from the USB device 210, Upon receipt of input data from the USB device 210, in Step S925, the information processing device 230 stores the input data into a corresponding USB buffer. In Step S927, the information processing device 230 determines whether or not a predetermined amount of input data set by the input-output file structure is received. When dm amount is not the predetermined amount, the information processing device 230 returns to Step S923 and receives next input data. When the amount reaches the predetermined amount, in Step S929, the information processing device 230 transfers the input data in the USB buffer to the input-output file structure. Then, in Step S931, the information processing device 230 determines whether or not the reception processing is completed. When the reception processing is not completed, the information processing device 230 returns to Step S923 and receives next input data.

By contrast in a case of output processing to the USB device 210, in Step S941, the information processing device 230 instructs output processing to the USB device 210, In this example, the communication structure is used, and the instruction is conveyed to the USB device 210 through the host controller interface 225 in the communication terminal 220. In Step S943, the information processing device 230 refers to the input-output file structure, acquires output data, transfers the output data to a corresponding USB buffer, and stores the output data into the buffer. Then, it Step S945, the information processing device 230 transmits the output data to the communication terminal 220. In Step S947, the information processing device 230 determines whether or not a predetermined amount of output data is transmitted in accordance with a type of the USB device 210, When the amount is not the predetermined amount, the information processing device 230 returns to Step S945 and repeats transmission of output data. When the amount reaches the predetermined amount, in Step S949, the information processing device 230 determines whether or not the output processing is completed. When the output processing is not completed, the information processing device 230 returns to Step S943, and acquires and transmits next output data.

When determining that the reception processing is completed or the output processing is completed, in Step S951, the information processing device 230 acquires input-output processing status. Then, in Step S953, the information processing device 230 passes the input-output processing status to the input-output file structure to notify the status to the application software 231.

<<Hardware Configuration of Communication Terminal>>

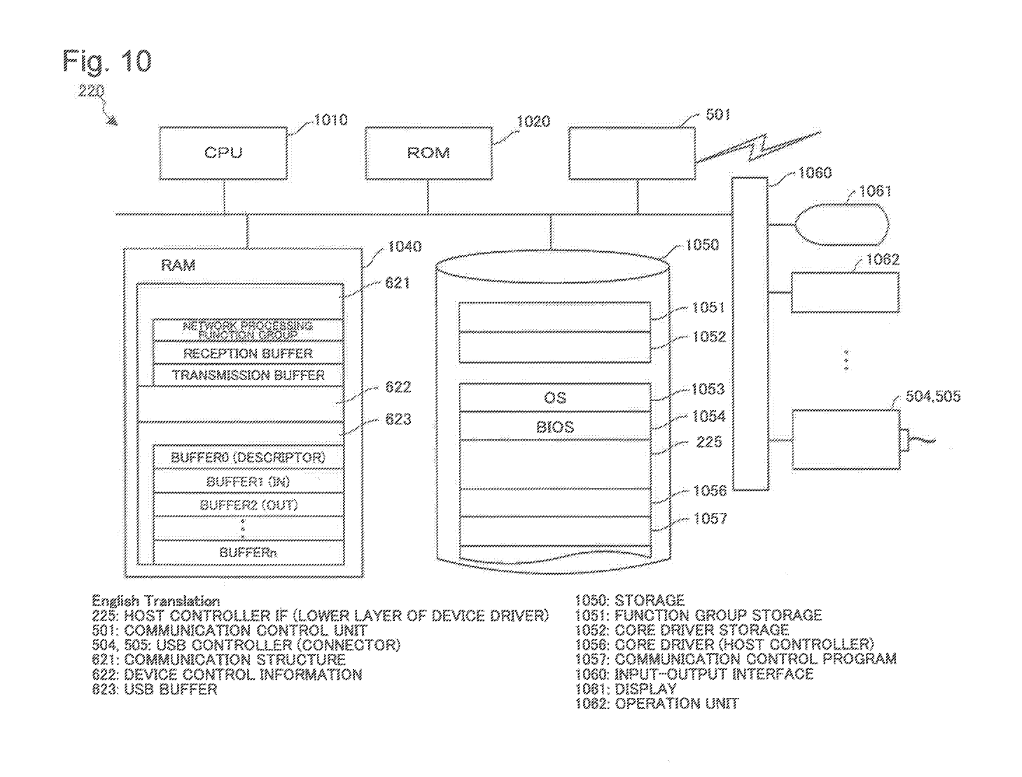

FIG. 10 is a block diagram illustrating a hardware configuration of the communication terminal 220 according to the second example embodiment.

In FIG. 10, a CPU 1010 is a processor for arithmetic control, and provides the functional components in the communication terminal 220 in FIG. 5 by executing a program. A ROM 1020 stores initial data, fixed data for a program and the like, and a program. Further, the communication control unit 501 communicates with the information processing device 230 through the network 240. The CPU 1010 is not limited to a single CPU, and may include a plurality of CPUs or a GPU for image processing. Further, it is desirable that the communication control unit 501 include a CPU independent of the CPU 1010, and write or read transmitted or received data Into or from a RAM 1040. Further, it is desirable that a DMAC (unillustrated) transferring data between the RAM 1040 and a storage 1050 be provided. Additionally, it is desirable that an input-output interface 1060 include a CPU independent of the CPU 1010, and write or read input-output data into or from the RAM 1040. Accordingly, the CPU 1010 processes data, recognizing that data are received by or transferred to the RAM 1040. Further, the CPU 1010 prepares the processing result in the RAM 1040 and delegates subsequent transmission or transfer to the communication control unit 501, the DMAC, or the input-output interface 1060.

The RAM 1040 is a random access memory used by the CPU 1010 as a work area for temporary storage. An area for storing data required for providing the second example embodiment is secured in the RAM 1040. The communication structure 621 is a structure for the host controller interface 225 to pass communication control by a communication control program 1057. The communication structure 621 includes areas for a network processing function group, a transmission buffer, and a reception buffer. The device control information 622 includes a control command group, a transfer mode, and status, for controlling a device. The USB buffer 623 is a buffer associated with a FIFO (endpoint) in the USB device 210, and includes a buffer 0 for control data and buffers 1 to n for data, in accordance with a type of the USB device 210, and input-output processing.

The storage 1050 stores a database, various types of parameters, or the following data or programs required for providing the second example embodiment. A function group storage 1051 stores a function used by the communication terminal 220 in a searchable manner A core driver storage 1052 stores a core driver in a device driver a host controller interface being part of the device driver, and the like in a searchable manner.

The storage 1050 stores the following programs. An OS 1053 is a basic program controlling the entire communication terminal 220. A BIOS 1054 is a basic program controlling an input-output operation of the communication terminal 220. The host controller interface 225 is a program providing an interface with the host controller as part of the device driver. A core driver 1056 including the host controller is a program for controlling USB serial communication. A communication control program 1057 is a program performing communication with the information processing device 230 by the communication control unit 501.

The input-output interface 1060 provides an interface for input-output data from and to input-output equipment. The input-output interface 1060 is connected to a display unit 1061, an operation unit 1062, and the USB controllers (connectors) 504 and 505, Further a speaker being an audio output unit, a microphone being an audio input unit, or a GPS position determination unit may be connected.

Note that a program and data related to a general purpose time don and another performable function, being implemented on the communication terminal 220, are not illustrated in die RAM 1040 and the storage 1050 in FIG. 10.

<<Processing Procedure of Communication Terminal>>

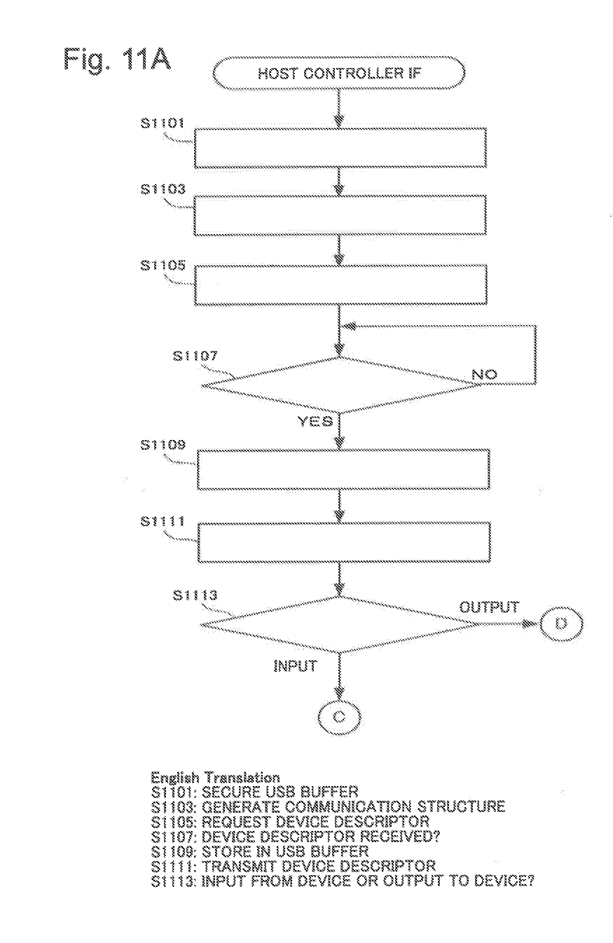

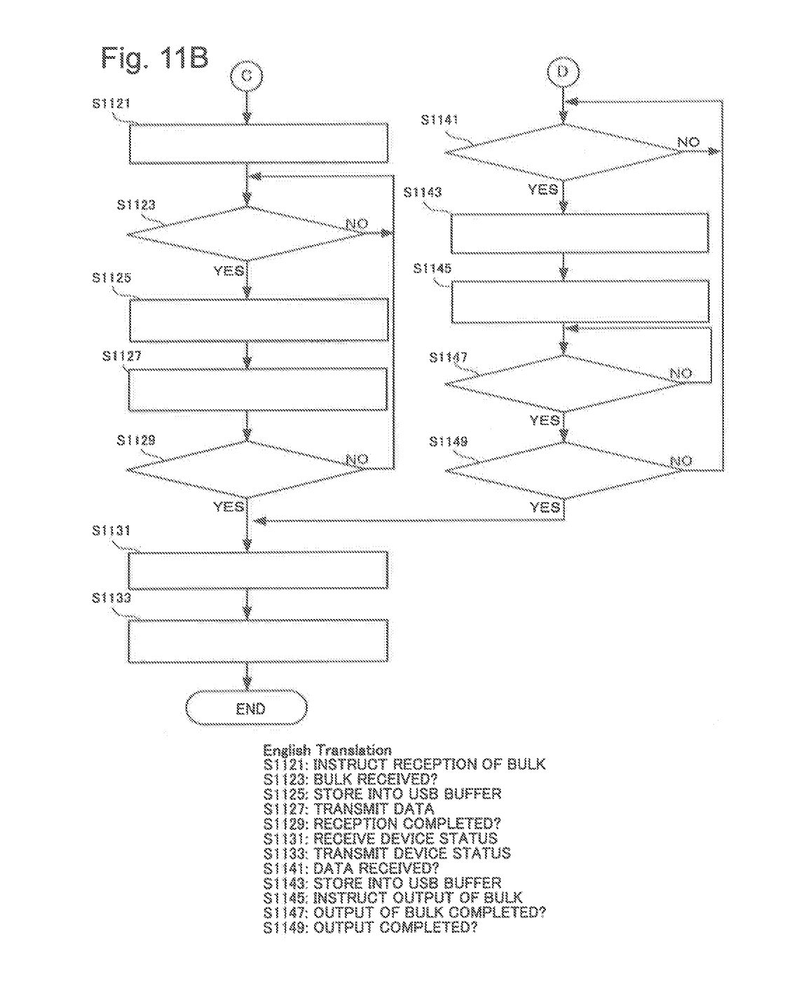

FIGS. 11A and 11B are flowcharts illustrating a processing procedure of the communication terminal 220 according to the second example embodiment. The CPU 1010 In FIG. 10 executes the flowcharts using the RAM 1040 to provide the functional components in FIG. 5. In FIGS. 11A and 11B, a processing procedure by the host controller interface 225 will be described.

In Step S1101, the communication terminal 220 secures a USB buffer associated with a FIFO (endpoint) in the USB device 210. in Step S1103, the communication terminal 220 generates a communication structure. In Step S1105, the communication terminal 220 requests a device descriptor to the USB device 210. Then, in Step S1107, the communication terminal 220 awaits acquisition of the device descriptor from the USB device 210.

Upon acquisition of the device descriptor of the USB device 210, in Step S1109, the communication terminal 220 sets the acquired device descriptor to the secured USB buffer 0. Then, in Step S1111, the communication terminal 220 transmits the acquired device descriptor to the information processing device 230. Next, in Step S1113, the communication terminal 220 determines whether the processing to be performed is reception processing from the USB device 210 or output processing to the USB device 210.

In a reception processing from the USB device 210, in Step S1121, the communication terminal 220 instructs the host controller in the USB bus interface 226 to receive bulk from the USB device 210. In Step S1123, the communication terminal 220 awaits to receive the bulk from the USB device 210. Upon receipt of the bulk from the USB device 210, in Step S1125, the communication terminal 220 stores the input data into a corresponding USB buffer. Then, in Step S1127, the communication terminal 220 transmits the input data stored in the USB buffer to the information processing device 230 through the communication unit. In Step S1129, the communication terminal 220 determines whether or not the reception processing is completed. When the reception processing is not completed, the communication terminal 220 returns to Step S1123 and awaits to receive next bulk.

By contrast, in an output processing to the USB device 210, in Step S1141, the communication terminal awaits reception of output data from the information processing device 230. Upon reception of the output data, in Step S1143, the communication terminal 220 transfers the output data to a corresponding USB buffer and stores the output data into the buffer. Then, in Step S1145, the communication terminal 220 instructs the host controller in the USB bus interface 226 to output bulk of the output data. In Step S1147, the communication terminal awaits completion of the bulk output from the USB buffer to a corresponding FIFO (endpoint) in the USB device. When the bulk output is completed, in Step S1149, the communication terminal 220 determines whether or not the output processing Is completed. When the output processing is not completed, the communication terminal returns to Step Si 141 and continues the data output to the USB device 210 instructed by the application software 231,

When determining that the reception processing is completed or the output processing is completed, in Step S1131, the communication terminal 220 acquires device states and stores the device status into a USB buffer. Then, in Step S1133, the communication terminal 220 transmits the device status to the information processing device 230 to notify the status to the application software 231.

The second example embodiment enables a USB device connected to a remote communication terminal to be operated in a same manner as a USB device directly connected to an information processing device.

<Third Example Embodiment>

Next, an information processing system according to a third example embodiment of the present invention will be described. The information processing system according to the third example embodiment differs front the aforementioned second example embodiment in directly connecting and operating a remote USB device through a network. The remaining configuration and operation are similar to the second example embodiment, and therefore a same configuration and a same operation are respectively given same reference signs, and detailed description thereof is omitted.

<<Concept of an Information Processing System>>

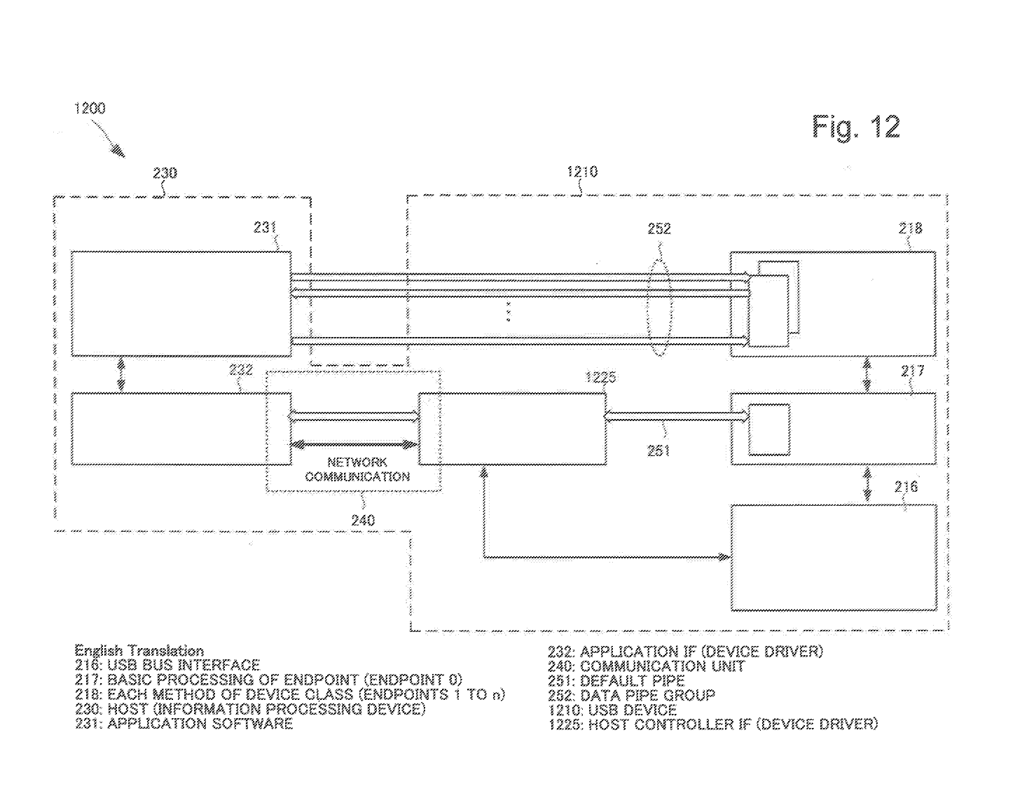

FIG. 12 is a diagram illustrating a concept of an information processing system 1200 according to the third example embodiment. Note that in FIG. 12, a same reference sign is given to a functional component similar to FIG. 2B, and description thereof is omitted. Further, in FIG. 12, illustration of regular software such as an OS and a BIOS is omitted.

The information processing system 1200 includes a USB device 1210 connected to a host 230 as an information processing device through a network 240. The USB device 1210 includes a host controller interface 1225 that directly communicates wife the host 230 and controls the device. Further, physical connection by a USB cable does not exist, and the host controller interface 1225 directly exchanges data between the USB buffer and FIFOs (endpoints) 0 to n through a USB bus interface 216.

Such a configuration enables a USB device remotely and directly connected through a network to be operated m a same manner as a USB device connected to an information processing device.

<<Functional Configuration of USB Device>>

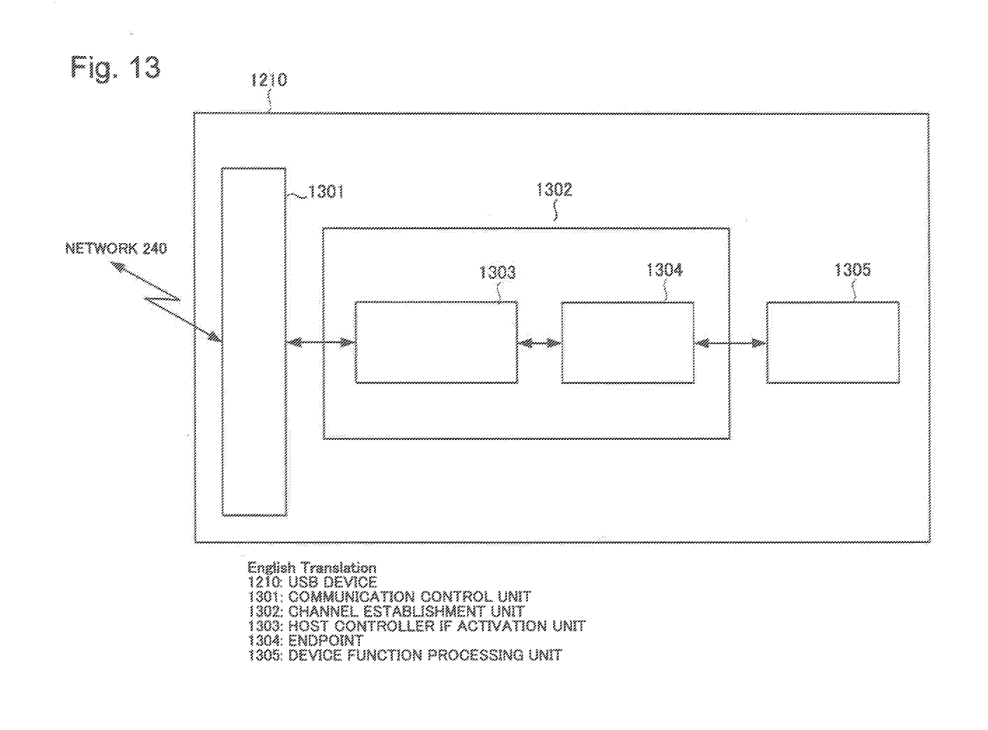

FIG. 13 is a block diagram illustrating a functional configuration of the USB device 1210 according to the third example embodiment. Note that, in FIG. 13, functional components deeply related to an operation according to the third example embodiment are illustrated, and a regular functional component included in the USB device 1210 is not illustrated.

The USB device 1210 includes a communication control unit 1301, a channel establishment unit 1302, and a device function processing unit 1305. The communication control unit 1301 controls communication with the information processing device 230 through the network 240. The channel establishment unit 1302 includes a host controller interface activation unit 1303, interfacing with a host controller and being part of a device driver, and a FIFO (endpoint) 1304 holding USB communication data, and establishes a control channel and a data channel between application software 231 in the information processing device 230 and the USB device 1210. The device function processing unit 1305 performs a device function using the endpoint 1304.

(Information Flow)

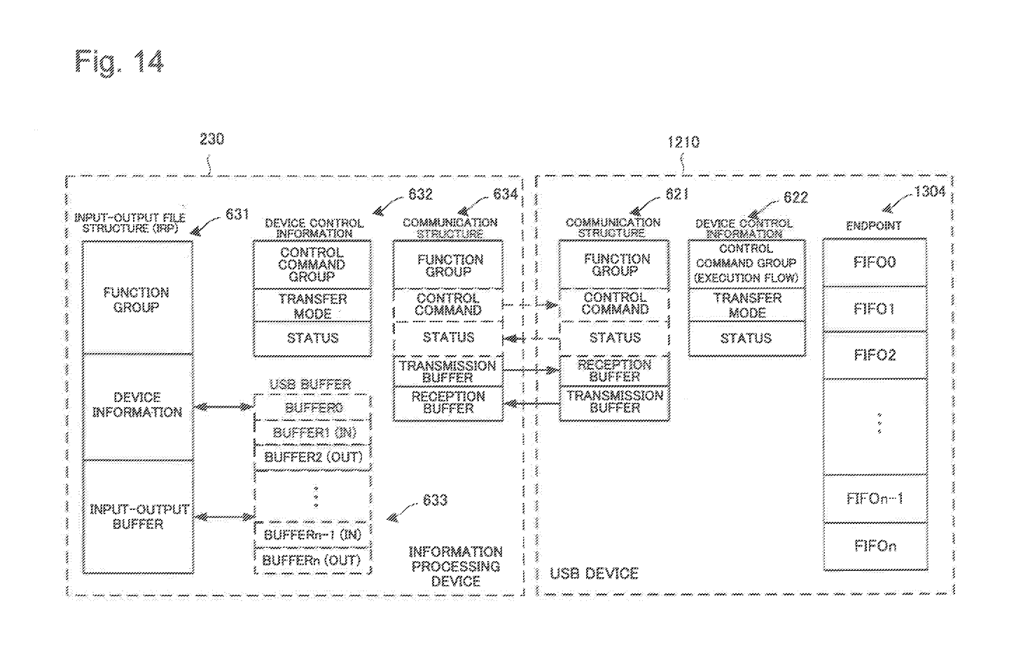

FIG. 14 Is a diagram illustrating an information flow in the information processing system 1200 according to the third example embodiment. Note that, in FIG. 14, a same reference sign is given to a component similar to a component in FIG. 6, and description thereof is omitted.

The USB device 1210 secures a communication structure 621, device control information 622, and the endpoint 1304, The endpoint 1304 includes FIFOs 0 to n in accordance with a device type,

<<Hardware Configuration of Device>>

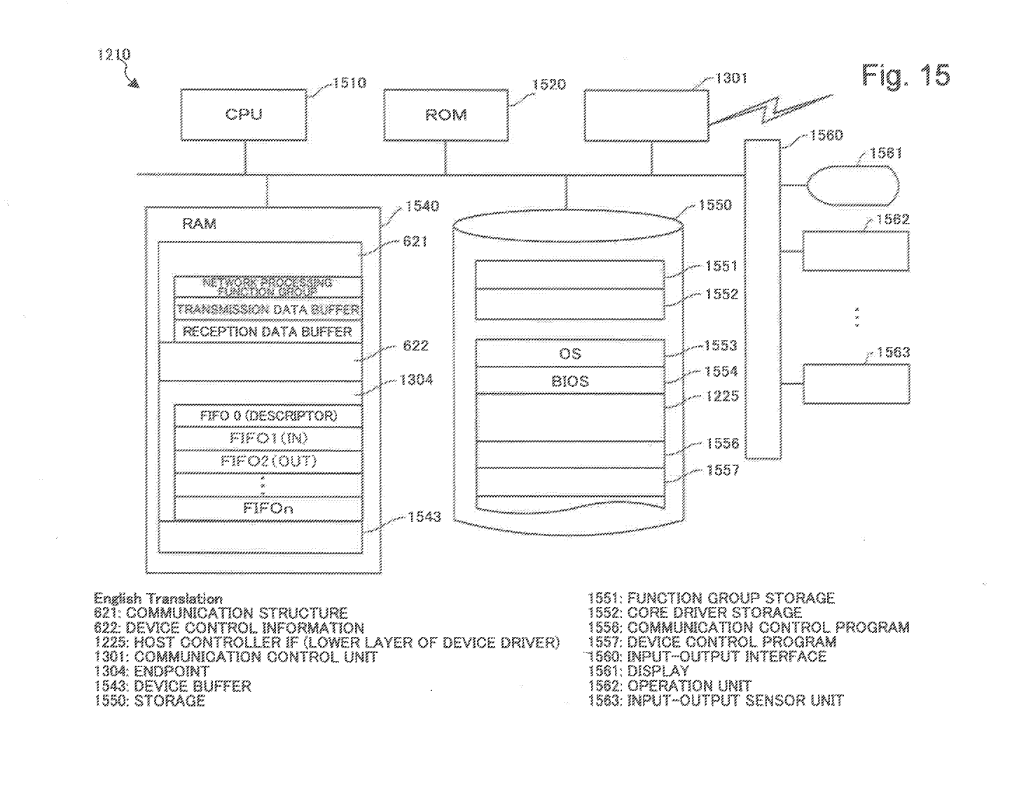

FIG. 15 is a block diagram illustrating a hardware configuration of the USB device 1210 according to the third example embodiment.

In FIG. 15, a CPU 1510 is a processor for arithmetic control, and provides the functional components in the USB device 1210 in FIG. 13 by executing a program. A ROM 1520 stores initial data, fixed data for a program and the like, and a program. Further, the communication control unit 1301 communicates with the information processing device 230 through the network 240. The CPU 1510 is not limited to a single CPU, and may include a plurality of CPUs or a GPU for image processing. Further, it is desirable that die communication control unit 1301 include a CPU independent of the CPU 1510, and write or read transmitted and received data into or from a RAM 1540. Further, it is desirable that a DMAC (unillustrated) transferring data between the RAM 1540 and a storage 1550 be provided. Additionally, it is desirable that an input-output interface 1560 include a CPU independent of the CPU 1510, and write or read input-output data into or from the RAM 1540. Accordingly, the CPU 1510 processes data, recognizing that data are received by or transferred to the RAM 1540, Further, the CPU 1510 prepares the processing result in the RAM 1540 and delegates subsequent transmission or transfer to the communication control unit 1301, the DMAC, or the input-output interface 1560.

The RAM 1540 is a random access memory used by the CPU 1510 as a work area for temporary storage. An area for storing data required for providing the third example embodiment is secured in the RAM 1540. The communication structure 621 is a structure for the host controller interface activation unit 1303 to pass communication control by a communication control program 1556. The communication structure 621 includes areas for a network processing function group, a transmission buffer, and a reception buffer. The device control information 622 includes a control command group, a transfer mode, and status, for controlling a device. The endpoint 1304 is an input-output buffer in the USB device 1210 and includes the FIFOs 0 to n in accordance with a variety of the USB device 1210. A device buffer 1543 is a buffer used by the CPU 1510 for processing in the USB device 1210.

The storage 1550 stores a database, various types of parameters, or the following data or programs required for providing the third example embodiment. A function group storage 1551 stores a function used by the USB device 1210 in a searchable manner A core driver storage 1552 stores a core driver in a device driver, a host controller interface being part of the device driven and the like in a searchable manner.

The storage 1550 stores the following programs. An OS 1553 is a basic program controlling the entire USB device 1210. A BIOS 1554 is a basic program controlling an input-output operation of the USB device 1210. The host controller interface 1225 is a program providing an interface with the host controller, as part of the device driver. A communication control program 1556 is a program performing communication with the information processing device 230 by the communication control unit 1301. A device control program 1557 is a program providing a function of the USB device 1210.

The input-output interface 1560 provides an interface for input-output data from and to input-output equipment. The input-output interface 1560 is connected to a display unit 1561, an operation unit 1562, and an input-output sensor unit 1563 in case that the USB device 1210 is a sensor device. Further, a speaker being an audio output unit, a microphone being an audio input unit, or a GPS position determination unit may be connected.

Note that a program and data related to a general-purpose function and another performable function, being implemented on the USB device 1210, are not illustrated in the RAM 1540 and the storage 1550 in FIG. 15.

<<Processing Procedure of Device>>

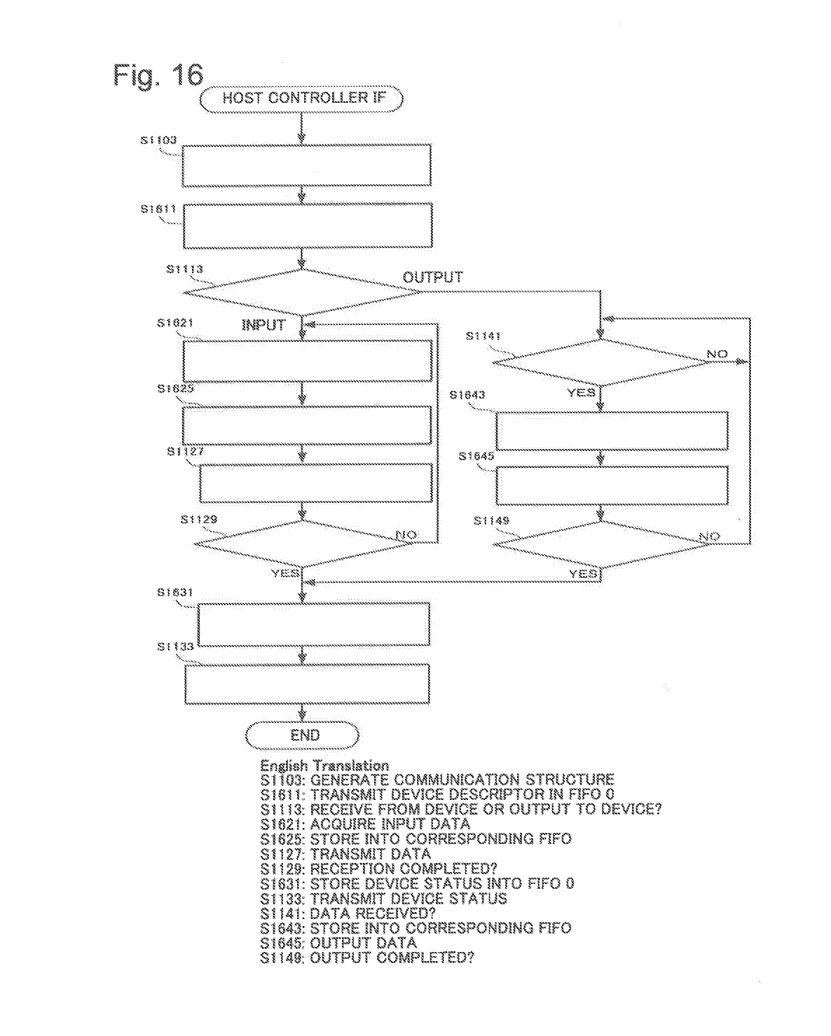

FIG. 16 is a flowchart illustrating a processing procedure of the USB device 1210 according to the third example embodiment. The CPU 1510 in FIG. 15 executes the flowchart using the RAM 1540 to provide the functional components in FIG. 13. In FIG. 16, a processing procedure by the host controller interface 1225 will be described. Further, in FIG. 16, a same step number is given to a step similar to FIG. 11A or 11B, and description thereof is omitted.

In Step S1611, the USB device 1210 transmits a device descriptor stored in the FIFO 0 to the information processing device 230.

In a case of reception processing from the USB device 1210, in Step S1621, the USB device 1210 acquires input data from, for example, the input-output sensor unit 1563. Then, in Step S1625, the USB device 1210 stores the input data into a corresponding FIFO.

By contrast, in a case of output processing to the USB device 1210, in Step S1643, the USB device 1210 stores output data received from the information processing device 230 into a corresponding FIFO. Then, in Step S1645, the USB device 1210 outputs the data from the FIFO.

In Step S1631, the USB device 1210 stores acquired input-output processing status into the FIFO 0.

The third example embodiment enables a USB device remotely and directly connected to a network to be operated in a same manner as a USB device connected to an information processing device.

<Fourth Example Embodiment>

Next, an information processing system according to a fourth example embodiment of the present invention will be described. The information processing system according to the fourth example embodiment differs from the aforementioned second and third example embodiments in connecting a remote USB hub. The remaining configuration and operation are similar to the second or third example embodiment, and therefore a same configuration and a same operation are respectively given same reference signs, and detailed description thereof is omitted.

<<Concept of information Processing System>>

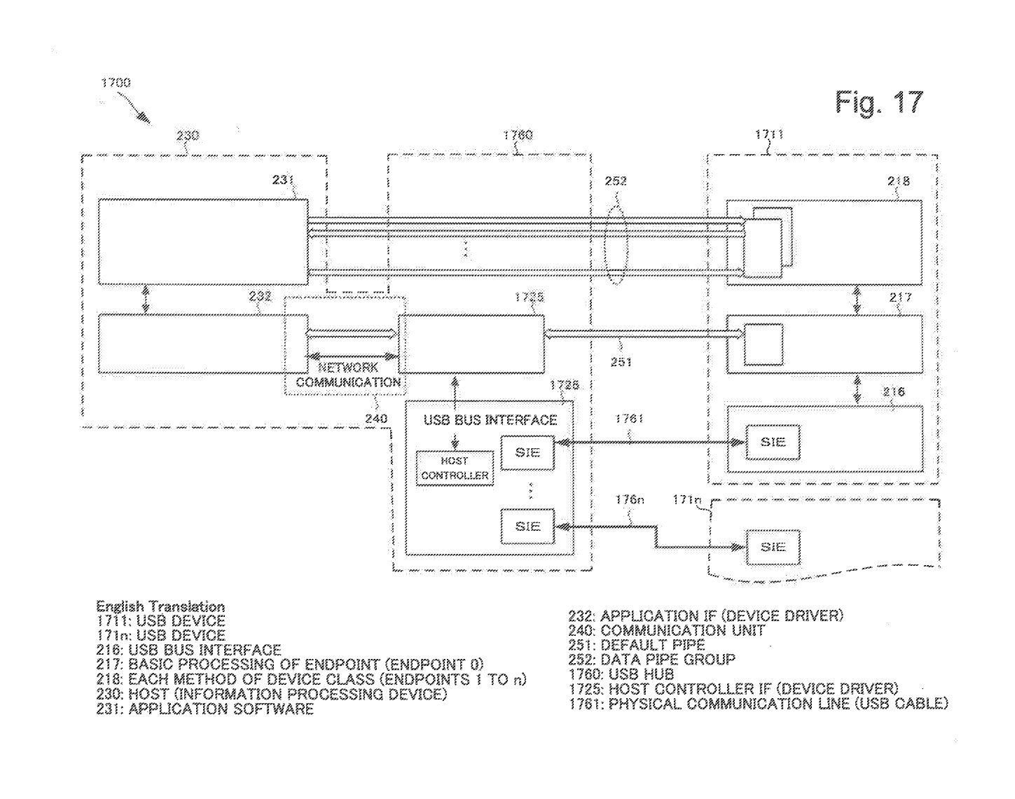

FIG. 17 is a diagram illustrating a concept of an information processing system 1700 according to the fourth example embodiment. Note that, in FIG. 17, a same reference sign is given to a component similar to a component in FIG. 2B, and description thereof is omitted.

The information processing system 1700 includes a USB hub 1760 and a plurality of USB devices 1711 to 171n. The USB bus 1760 includes a host controller interface 1725 and a USB bus interface 1726 branching into a plurality of SIEs. The host controller interface 1725 has a function for branching into a plurality of USB cables. Further, the respective plurality of SIEs are connected to respective SIEs in a plurality of USB devices 1711, to 171n through a plurality of USB cables 1761 to 176n.

<<Functional Configuration of USB Hub>>

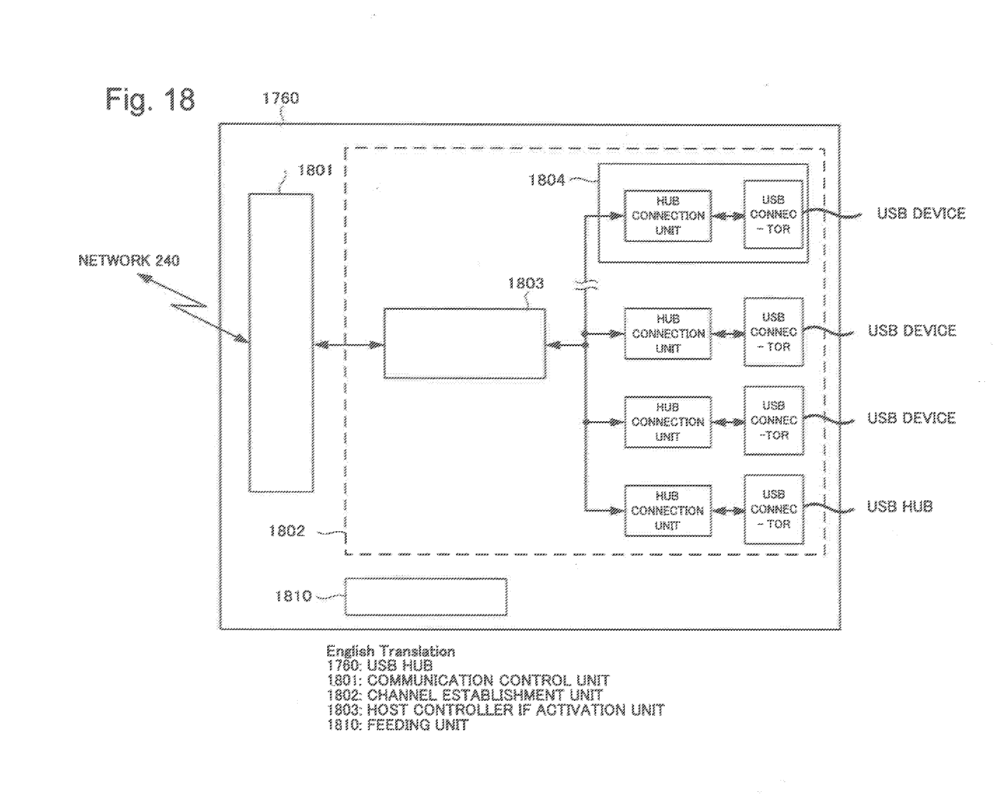

FIG. 18 is a block diagram illustrating a fractional configuration of the USB hub 1760 according to the fourth example embodiment.

The USB hub 1760 includes a communication control unit 1801, a channel establishment unit 1802, and, as an option, a feeding unit 1810. The communication control unit 1801 controls communication with an information processing device 230 through a network 240. The channel establishment unit 1802 includes a host controller interface function unit 1803, interfacing with a host controller and being part of a device driver, and sets 1804 of hub connection units and USB connectors, the number of which being a number of branches in the USB hub 1760.

(Information Flow)

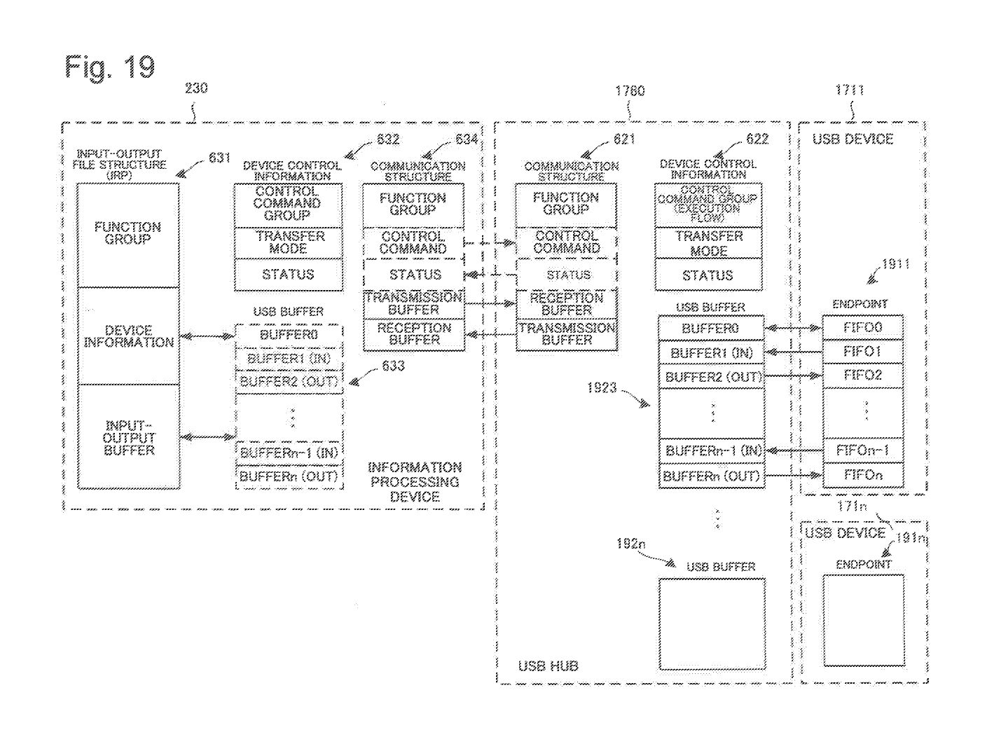

FIG. 19 is a diagram illustrating an information flow in the information processing system 1700 according to the fourth example embodiment. Note that, in FIG. 19, a same reference sign is given to a component similar to a component in FIG. 6, and description thereof is omitted.

A communication structure 621, device control information 622, and a plurality of USB buffers 1923 to 192n are secured in the USB hub 1760. The communication structure 622 is a structure associated with a communication structure 633 secured by an application interface 232. The USB buffers 1911 to 191n include buffers secured when a device type is a USB device, corresponding to respective endpoints in the USB devices 1711 to 171n.

FIFOs 0 to n are prepared as endpoints 1911 to 191n in the USB devices 1211 to 171n, respectively, in accordance with a device type.

<<Hardware Configuration of USB Hub>>

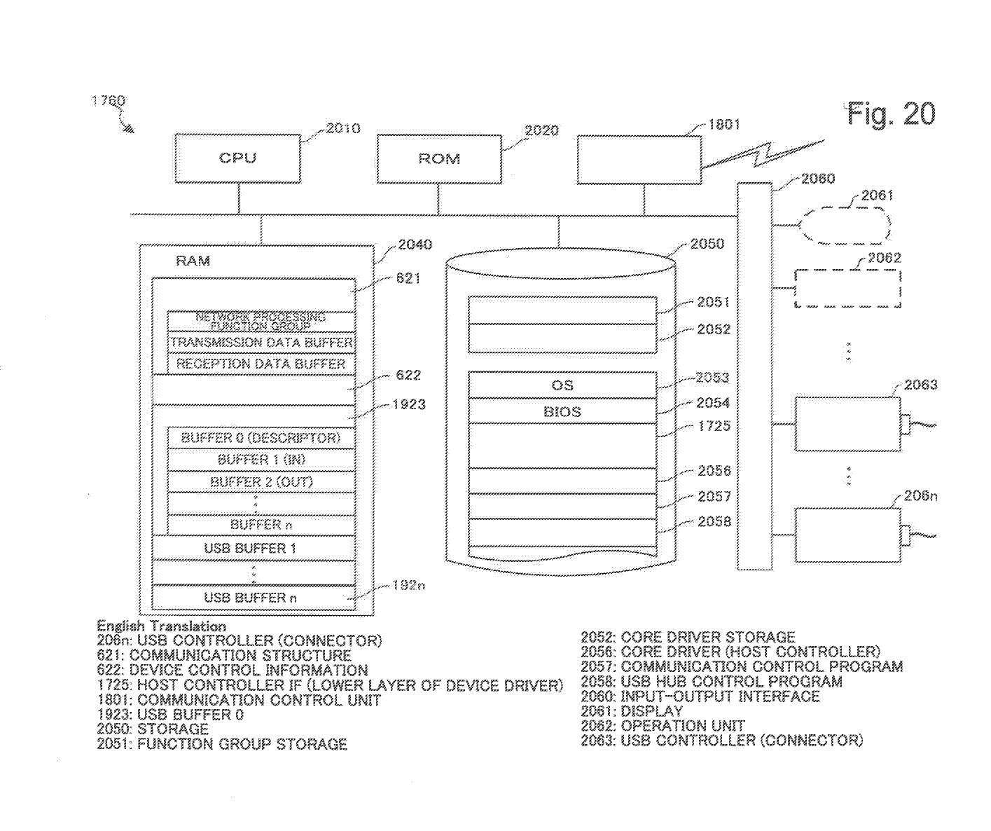

FIG. 20 is a block diagram illustrating a hardware configuration of the USB hub 1760 according to the fourth example embodiment.

In FIG. 20, a CPU 2010 is a processor for arithmetic control, and provides the functional components of the USB hub 1760 in FIG. 18 by executing a program. A ROM 2020 stores initial data, fixed data for a program and the like, and a program. Further, the communication control unit 1801 communicates with the information processing device 230 through the network 240. The CPU 2010 is not limited to a single CPU, and may include a plurality of CPUs or a GPU for image processing. Further, it is desirable that the communication control unit 1801 include a CPU independent of the CPU 2010, and write or read transmitted and received data into or front a RAM 2040. Further, it is desirable that a DMAC (unillustrated) transferring data between the RAM 2040 and a storage 2050 be provided. Additionally, it is desirable that an input-output interface 2060 include a CPU independent of the CPU 2010, and write or read input-output data into or from the RAM 1040. Accordingly, the CPU 2010 processes data, recognizing that data are received by or transferred to the RAM 2040. Further, the CPU 2010 prepares the processing result in the RAM 2040, and delegates subsequent transmission or transfer to the communication control unit 1801, the DMAC, or the input-output interface 2060.

The RAM 2040 is a random access memory used by the CPU 2010 as a work area for temporary storage. An area for storing data required for providing the fourth example embodiment is secured in the RAM 2040. The communication structure 621 is a structure for the host controller interface 1725 to pass communication control by a communication control program 2057. The communication structure 621 includes areas for a network processing function group, a transmission buffer, and a reception buffer. The device control Information 622 includes a control command group, a transfer mode, and status, for controlling a device. The USB buffer 0 (1923) is a buffer associated with a FIFO (endpoint) in the USB device 1711, and includes a buffer 0 for control data and buffers 1 to n for data, in accordance with a type of the USB device 1711 and input-output processing. Further, the USB buffer n (192n) is a buffer associated with a FIFO (endpoint) in the USB device 171n, and includes a buffer 0 for control data and buffers 1 to n for data, in accordance with a type of the USB device 171n and input-output processing.

The storage 2050 stores a database, various types of parameters, or the following data or programs required for providing the fourth example embodiment. A function group storage 2051 stores a function used by the USB hub 1760 in a searchable manner. A core driver storage 2052 stores a core driver in a device driver, the host controller interface being part of the device driver, and the like in a searchable manner.

The storage 2050 stores the following programs. An OS 2053 is a basic program controlling the entire USB hub 1760, A BIOS 2054 is a basic program controlling an input-output operation of the USB hub 1760. The BIOS 2054 is not required when the USB hub 1760 does not have an input-output operation function. The host controller interface 1725 is a program providing an interface with the host controller, as part of the device driver. A core driver 2056 including the host controller is a program for controlling USB serial communication, A communication control program 2057 is a program performing communication with the information processing device 230 by the communication control unit 1801. A USB hub control program 2058 is a program providing a function of the USB hub 1760.

The input-output interface 2060 provides an interface for input-output data from and to input-output equipment. The input-output interface 2060 is connected to USB controllers (connectors) 2063 to 206n. Further, when the USB hub 1760 has an input-output operation function, a display unit 2061, an operation unit 2062, a speaker being an audio output unit, a microphone being an audio input unit, or a GFS position determination unit may be connected.

Note that a program and data related to a general-purpose function and another performable function, being implemented on the USB hub 1760, are not illustrated in the RAM 2040 and the storage 2050 in FIG. 20.

<<Processing Procedure of USB Hub>>

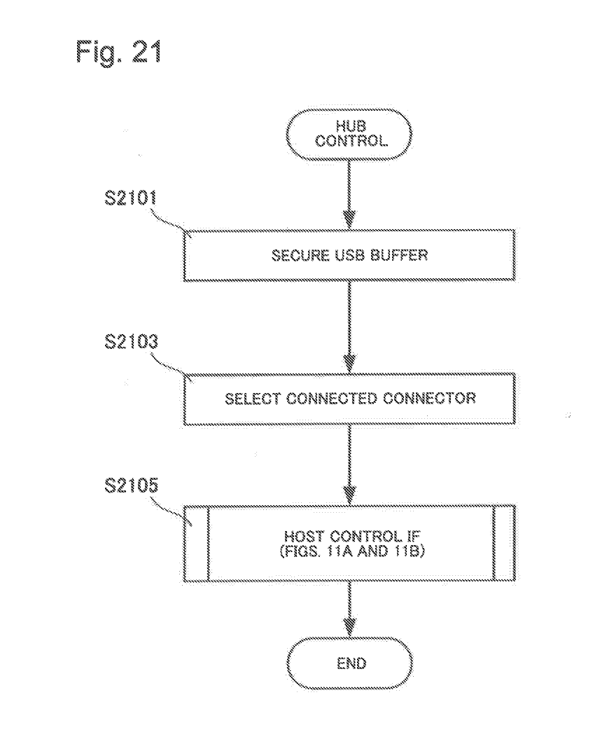

FIG. 21 is a flowchart illustrating a processing procedure of the USB hub 1760 according to the fourth example embodiment. The CPU 2010 executes the flowchart using the RAM 2040 in FIG. 20 to provide the functional components in FIG. 18.

In Step S2101, the USB hub 1760 secures a USB buffer corresponding to a branched USB connector, or a USB buffer corresponding to a USB connector connected to a USB cable. In Step S2103, the USB hub 1760 recognizes a USB connector connected to a USB cable and selects the connector as a processing target. Then, in Step S2105, the USB hub 1760 performs host control interface processing. The host control interface processing in Step S2105 is similar to the processing described above by referring to FIGS. 11A and 11B, for each USB connector, and therefore description thereof is omitted.

The fourth example embodiment enables a plurality of USB devices connected to a USB hub remotely connected through a network to be operated in a same manner as USB devices connected to an information processing device.

<Fifth Example Embodiment>

Next, an information processing system according to a fifth example embodiment of the present invention will be described. The information processing system according to the fifth example embodiment differs from the aforementioned second to fourth example embodiments in that a serial bus connected to a device is HDMI®. The remaining configuration and operation are similar to the second to fourth example embodiments, and therefore a same configuration and a same operation are respectively given same reference signs, and detailed description thereof is omitted.

<<Concept of Information Processing System>>

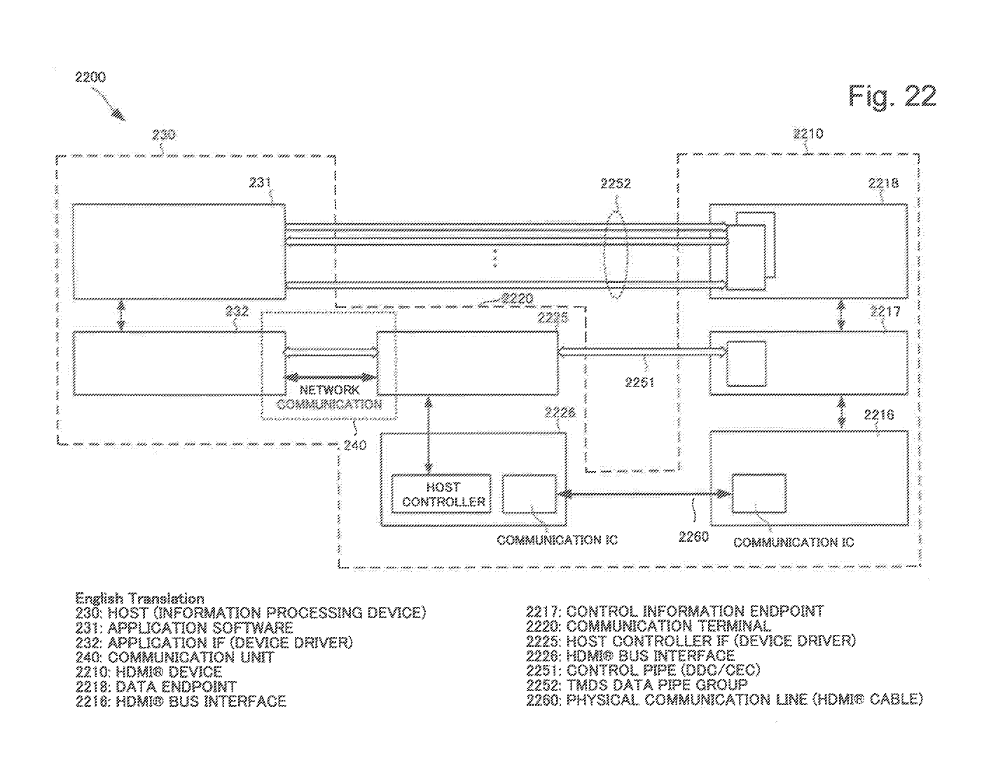

FIG. 22 is a diagram illustrating a concept of an information processing system 2200 according to the fifth example embodiment. Note that, in FIG. 22, a same reference sign is given to a component similar to a component in FIG. 2B, and description thereof is omitted.

The information processing system 2200 in FIG. 22 includes a host 230 as an information processing device, a remote communication terminal 2220 connected to the host 230 through a network 240, and an HDMI(r) device 2210 connected to an HDMI® connector on the communication terminal 2220.

The communication terminal 2220 includes, as software, a host controller interface 2225 as part of a device driver, and an HDMI® bus interface 2226 including a host controller and a communication IC, The host controller interface 2225 passes a command, data, and the like, conforming to an HDMI® protocol and being received from an application interface 232 through the network 240, to the host controller in the HDMI® bus interface 2226 in a format understandable to the host controller. Further, the host controller interface 2225 transmits data, device status, and the like, being passed from the host controller in the HDMI® bus interface 2226, to the application interface 232 through the network 240. The host controller in the HDMI® bus interface 2226 performs serial communication through an HDMI® cable 2260 in accordance with an HDMI® protocol, while exchanging a command, data, and the like with the host controller interface 2225. The communication IC In the HDMI(r) bits interface 2226 controls a signal over the HDMI® cable 2260 in accordance with art HDMI® communication specification.

The HDMI® device 2210 includes, as software, an HDMI® bus interface 2216 in the HDMI® device 2210 that is connected to the HDMI® bus interface 2226 in the communication terminal 2220 through the HDMI® cable 2260 and exchanges a signal with the HDMI® bus interface 2226. Further, the HDMI® device 2210 includes an endpoint 2217 of control Information, storing a descriptor including device information and control information, and an endpoint 2218 storing input-output data.

By such connection, the communication terminal 2220 and the HDMI® device 2210 perform physical-level communication by the own HDMI® bus interfaces 2226 and 2216. Further, by a system-level control transfer through the application interface 232, the network 240, and the host controller interface 2225, control communication as basic processing is provided between application software 231 and the endpoint 2217 through a control pipe (display data channel/Consumer Electronics Control (DDC/CEC)) 2251. Further, in an application-level data transfer, TMDS data communication as each method of a device class is provided between the application software 231 and the endpoint 2218 through a data pipe group 2252.

As described above, a unified communication channel (pipe) can be formed by network communication between the application interface 232 in the host 230 and the host controller Interface 2225 in the communication terminal 2220 through the network 240, and serial communication between the HDMI® bus interfaces 2226 and 2216 through the HDMI® cable.

(Information Flow)

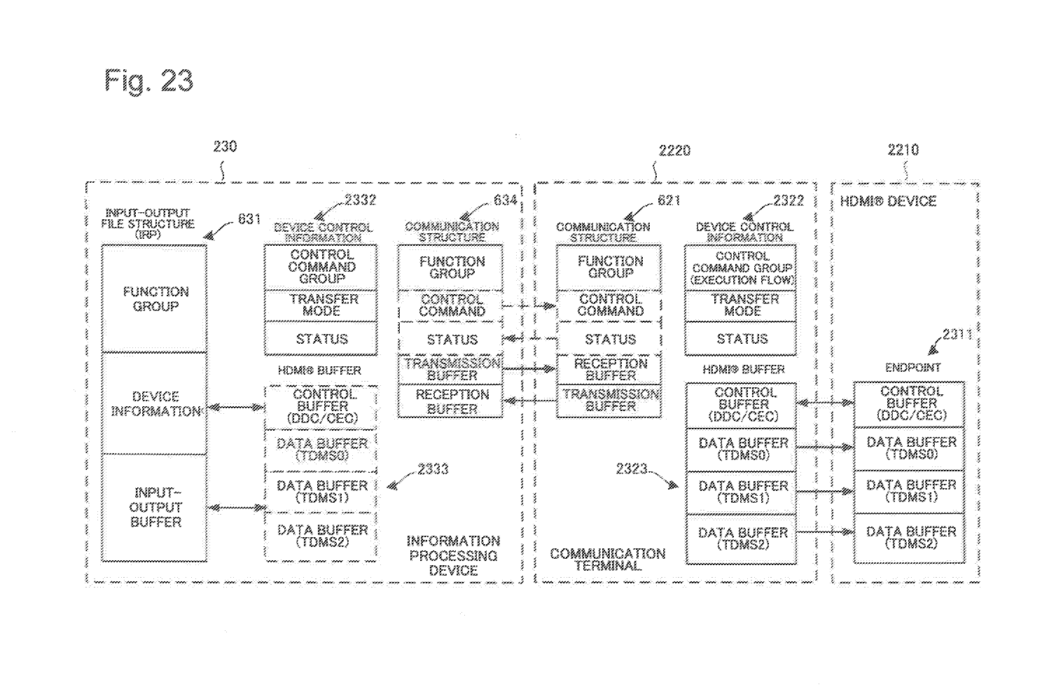

FIG. 23 is a diagram illustrating an information flow in the information processing system 2200 according to the fifth example embodiment. Note that, in FIG. 23, a same reference sign is given to a component similar to a component in FIG. 6, and description thereof is omitted.

Device control information 2332 in the information processing device 230 includes a transmitted and received control command group in HDMI®, a current transfer mode, and status. The control command group includes control commands for controlling a setting related to communication, an action against a communication error, and the like, in addition to control commands for controlling input and output from and to an HDMI(r) device. The device control information 2332 may be integrated into device information in an input-output file structure 631. An HDMI® buffer 2333 in the information processing device 230 is a buffer for the HDMI® device 2210, being secured by the application interface 232 in accordance with HDMI® serial data communication defined by the input-output file structure 631. The HDMI® buffer 2333 includes a control buffer storing a control signal and a data buffer storing data in a Technical Data Management Streaming (TDMS) file format, file input-output file structure 631 and a communication structure 634 may directly exchange data without providing the HDMI® buffer 2333.

The device control Information 2332 in the communication terminal 2220 includes a transmitted and received control command group in HDMI® a current transfer mode, and status. The control command group includes control commands for controlling a setting related to communication, an action against a communication error, and the like, it; addition to control commands for controlling input and output from and to the HDMI® device. An HDMI® buffer 2323 in the communication terminal 2220 is secured in association with an endpoint 2311 in the HDMI® device 2210, arid a structure thereof is similar to the HDMI® buffer 2333. Further, the endpoint 2311 in the HDMI® device 2210 is prepared in accordance with a type of the HDMI® device 2210, a data format, and the like.

Even when HDMI® is used as a serial bus, the fifth example embodiment enables a remotely connected HDMI® device to be operated in a same manner as an HDMI® device directly connected to an information processing device, similarly to the aforementioned example embodiments.

<Sixth Example Embodiment>

Next, an information processing system according to a sixth example embodiment of the present invention will be described. The information processing system according to the sixth example embodiment differs from the aforementioned second to fifth example embodiments in that a serial bus connected to a device is SCSI. The remaining configuration and operation are similar to the second to fifth example embodiments and therefore a same configuration and a same operation are respectively given same reference signs, and detailed description thereof is omitted.

<<Concept of Information Processing System>>

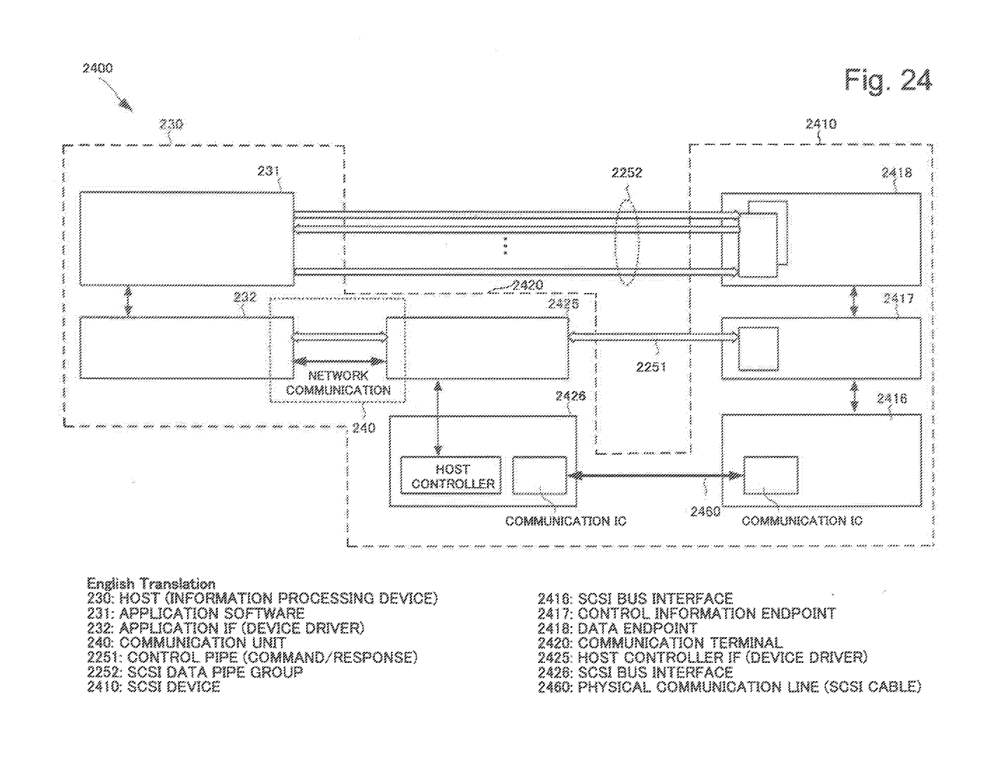

FIG. 24 is a diagram illustrating a concept of an information processing system 2400 according to the sixth example embodiment. Note that, in FIG. 24, a same reference sign is given to a component similar to a component in FIG. 2B, and description thereof is omitted.

The information processing system 2400 in FIG. 24 includes a host 230 as an information processing device, a remote communication terminal 2420 connected to the host 230 through a network 240, and a SCSI device 2410 connected to a SCSI connector on the communication terminal 2420.

The communication terminal 2420 includes, as software, a host controller interface 2425 as part of a device driver, and a SCSI bus interface 2426 including a host controller and a communication IC. The host controller interface 2425 passes a command, data, and the like, conforming to a SCSI protocol and being received from an application interface 232 through the network 240, to the host controller in the SCSI bus interface 2426 in a format understandable to the host controller. Further, the host controller interface 2425 transmits data, device status, and the like, being passed from the host controller in the SCSI bus interface 2426, to the application interface 232 through the network 240. The host controller in the SCSI bus interface 2426 performs serial communication through a SCSI cable 2460 in accordance with a SCSI protocol, while exchanging a command, data, and the like with the host controller interface 2425. The communication IC in the SCSI bus interface 2426 controls a signal over the SCSI cable 2460 in accordance with a SCSI communication specification.

The SCSI device 2410 includes, as software, a SCSI bus interface 2416 in the SCSI device 2410 that is connected to the SCSI bus interface 2426 in the communication terminal 2420 through the SCSI cable 2460 and exchanges a signal with the SCSI bus interface 2426. Further, the SCSI device 2410 includes an endpoint 2417 of control information, storing a descriptor including device information and control information, and an endpoint 2418 storing input-output data.

By such connection, the communication terminal 2420 and the SCSI device 2410 perform physical-level communication by the own SCSI bus interfaces 2426 and 2416. Further by a system-level control transfer through the application interface 232, the network 240, and the host controller interface 2425, control communication as basic processing is provided between application software 231 and the endpoint 2412 through a control pipe (SCSI command/SCSI response) 2451. Further, in an application-level data transfer, SCSI data communication as each method of a device class is provided between the application software 231 and the endpoint 2418 through a data pipe group 2452.

As described above, a unified communication channel (pipe) can be formed by network communication between the application interface 232 In the host 230 and the host controller interface 2425 in the communication terminal 2420 through the network 240, and serial communication between the SCSI bus interfaces 2426 and 2416 through the SCSI cable.

(Information Flow)

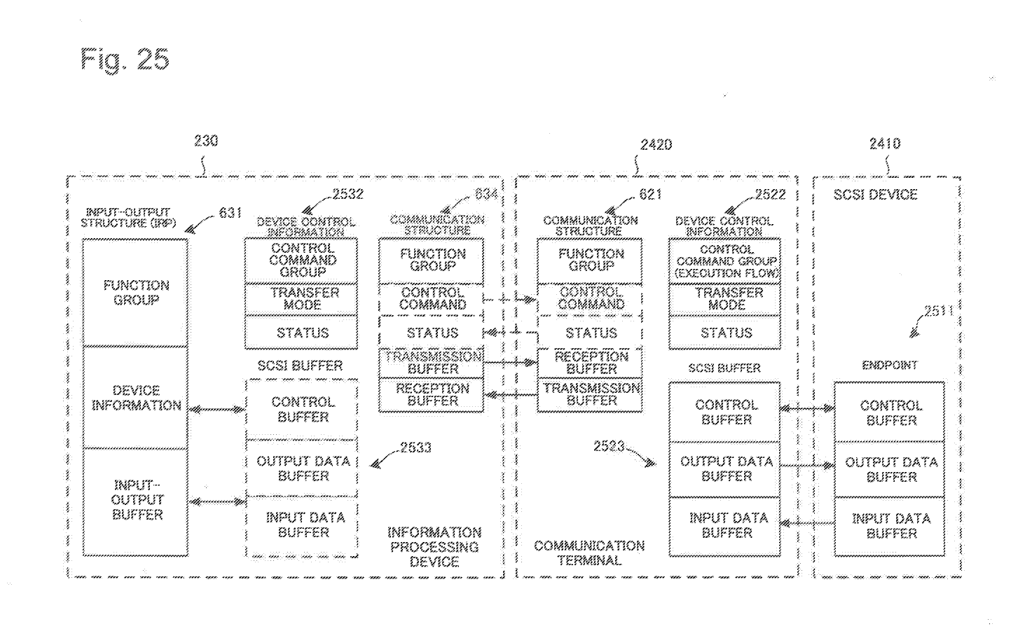

FIG. 25 is a diagram illustrating an information flow in the information processing system 2400 according to the sixth example embodiment. Note that, in FIG. 25, a same reference sign is given to a component similar to a component in FIG. 6, and description thereof is omitted.

Device control information 2532 in the information processing device 230 includes a transmitted and received control command group in SCSI, a current transfer mode, and status. The control command group includes control commands for controlling a setting related to communication, an action against a communication error, and the like, in addition to control commands for controlling input and output from and to the SCSI device. The device control information 2532 may be integrated into device information in an input-output file structure 631. A SCSI buffer 2533 in the information processing device 230 is a buffer for the SCSI device 2410, being secured by the application interface 232 in accordance with SCSI serial data communication defined by the input-output file structure 631. The SCSI buffer 2533 includes a control buffer storing a control signal and a data buffer storing data. The input-output file structure 631 and a communication structure 634 may directly exchange data without providing the SCSI buffer 2533.

Device control information 2522 in the communication terminal 2420 includes transmitted and received control command group in SCSI, a current transfer mode, and status. The control command group includes control commands for controlling a setting related to communication, an action against a communication error, and the like, in addition to control commands for controlling input and output from and to the SCSI device. A SCSI buffer 2523 in the communication terminal 2420 is secured in association with an endpoint 2511 in the SCSI device 2410, and a structure thereof is similar to the SCSI buffer 2533. Further, the endpoint 2511 in die SCSI device 2410 is prepared in accordance with a type of the SCSI device 2410, a data format, and the like.

Even when SCSI is used as a serial bus, the sixth example embodiment enables a remotely connected SCSI device to be operated in a same manner as a SCSI device directly connected to an information processing device, similarly to the aforementioned example embodiments.

<Seventh Example Embodiment>

Next, an information processing system according to a seventh example embodiment of the present invention will be described. The information processing system according to the seventh example embodiment differs from the aforementioned second to sixth example embodiments In that a remotely connected device is an SD card. The remaining configuration and operation are similar to the second to sixth example embodiments, and therefore a same configuration and a same operation are respectively given same reference signs, and detailed description thereof is omitted.

<<Concept of Information Processing System>>

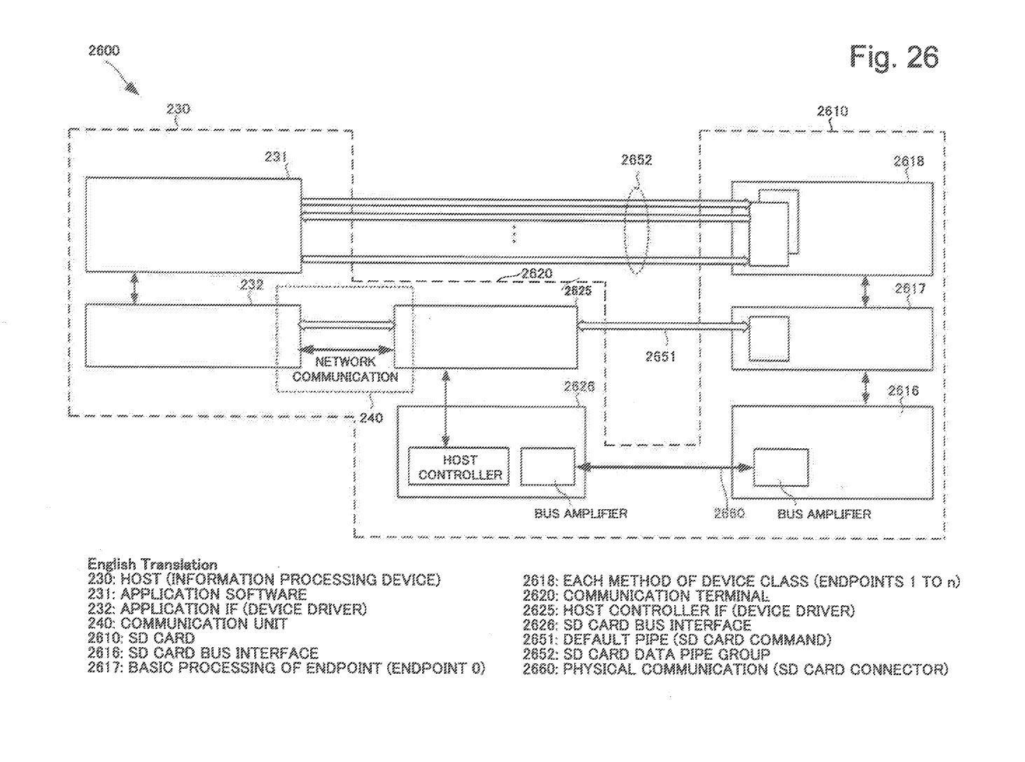

FIG. 26 is a diagram illustrating a concept of an information processing system 2600 according to the seventh example embodiment. Note that, in FIG. 26, a same reference sign is given to a component similar to a component in FIG. 2B, and description thereof is omitted.

The information processing system 2600 in FIG. 26 includes a host 230 as an information processing device, a remote communication terminal 2620 connected to the host 230 through a network 240, and an SD card 2610 connected to a connector on the communication terminal 2620.

The communication terminal 2620 includes, as software, a host controller interface 2625 as part of a device driver, and an SD card bus interface 2626 including a host controller and a bus amplifier. The host controller interface 2625 passes a command, data, and dm like, conforming to an SD card protocol and being received from an application interface 232 through the network 240, to the host controller in the SD card bus interface 2626 in a format understandable to the host controller. Further, the host controller interface 2625 transmits data, device status, and the like, being passed from the host controller in the SD card bus interface 2626, to the application interface 232 through the network 240, The host controller in the SD card bus interface 2626 performs serial communication through an SD card connector 2660 in accordance with an SD card protocol, while exchanging a command, data, and the like with the host controller interface 2625. The bus amplifier in the SD card bus interface 2626 controls a signal on the SD card connector 2660 in accordance with an SD card communication specification.

The SD card 2610 includes, as software, an SD card bus interface 2616 in the SD card 2610 that is connected to the SD card bus interface 2626 in the communication terminal 2620 through the SD card connector 2660 and exchanges a signal with the SD card bus interface 2626. Further, the SD card 2610 includes an endpoint 2617 of control information, storing a descriptor including device information and control information, and an endpoint 2618 storing input-output data.

By such connection, the communication terminal 2620 and the SD card 2610 perform physical-level communication by the own SD card bus interfaces 2626 and 2616. Further, by a system-level control transfer through the application interface 232, the network 240, and the host controller interface 2625, control communication as basic processing is provided between application software 231 and the endpoint 2617 through a control pipe (SD card command) 2651. Further, in an application-level data transfer, data communication as each method of a device class is provided between the application software 231 and the endpoint 2618 through a data pipe group 2652.

As described above, a unified communication channel (pipe) can be formed by network communication between the application interface 232 in the host 230 and the host controller interface 2625 in the communication terminal 2620 through the network 240, and serial communication between the SD card bus interfaces 2626 and 2616 through the SD card connector.

(Information Flow)

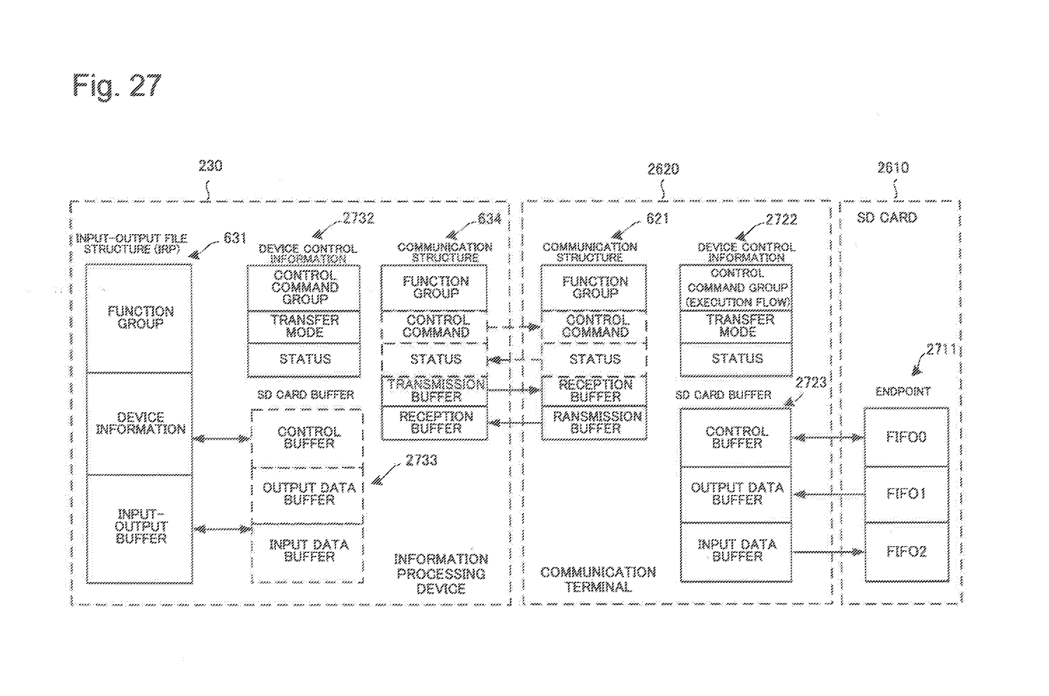

FIG. 22 is a diagram illustrating an information flow in the information processing system 2600 according to the seventh example embodiment. Note that, in FIG. 27, a same reference sign is given to a component similar to a component m FIG. 6, and description thereof is omitted.

Device control information 2732 in the information processing device 230 includes transmitted and received control command group in the SD card, a current transfer mode, and status. The control command group includes control commands for controlling a setting related to communication, an action against a communication error, and the like, in addition to control commands for controlling input and output from and to the SD card. The device control information 2732 may be integrated into device information in an input-output file structure 631. An SD card buffer 2733 in the information processing device 230 is a buffer for the SD card 2610, being secured by the application interface 232 in accordance with SD card serial data communication defined by the input-output file structure 631. The SD card buffer 2733 includes a control buffer storing a control signal and a data buffer storing data. The input-output file structure 631 and a communication structure 634 may directly exchange data without providing the SD card buffer 2733.

Device control information 2722 in the communication terminal 2620 includes a transmitted and received control command group in the SD card, a current transfer mode, and status. The control command group includes control commands for controlling a setting related to communication, an action against a communication error, and the like, in addition to control commands for controlling input and output from and to the SD card. An SD card buffer 2723 in the communication terminal 2620 is secured in association with an endpoint 2711 in the SD card 2610, and a structure thereof is similar to the SD card buffer 2733. Further, the endpoint 2711 in the SD card 2610 is prepared in accordance with a type of the SD card 2610, a data format, and the like.

Even when a remotely connected device is a DC card, the seventh example embodiment enables the DC card to be operated in a same manner as a DC card directly connected to an information processing device, similarly to the aforementioned example embodiments.

<Eighth Example Embodiment>

Next, an information processing system according to an eighth example embodiment of the present invention will be described. The information processing system according to the eighth example embodiment differs from the aforementioned second to seventh example embodiments in that a device is connected to a remote communication terminal by short-distance wireless communication (proximity wireless communication). The remaining configuration and operation are similar to the second to seventh example embodiments, and therefore a same configuration and a same operation are respectively given same reference signs, and detailed description thereof is omitted.

<<Information Processing System>>

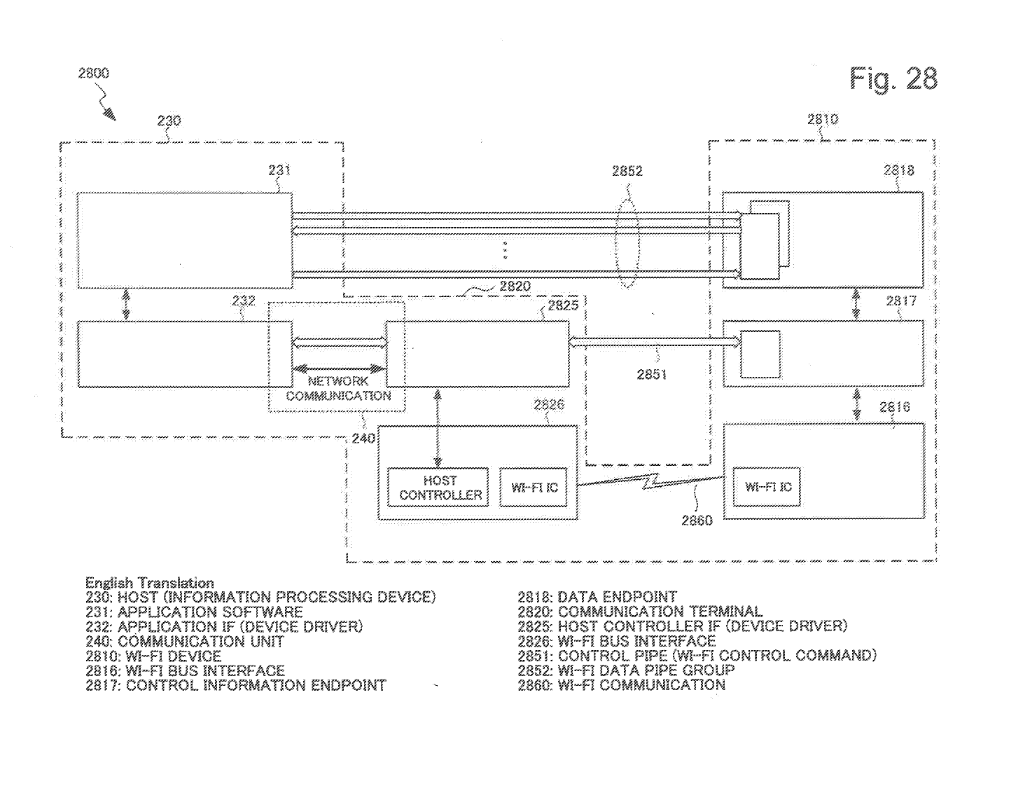

FIG. 28 is a diagram illustrating a concept of an information processing system 2800 according to the eighth example embodiment. FIG. 28 illustrates a case that a remote communication terminal is connected to a device by Wi-Fi communication. Note that, in FIG. 28, a same reference sign is given to a component similar to a component in FIG. 2B and description thereof is omitted.

The information processing system 2800 in FIG. 28 includes a host 230 as an information processing device, a remote communication terminal 2820 connected to the host 230 through a network 240, and a Wi-Fi device 2810 connected to the communication terminal 2820 by Wi-Fi wireless communication.

The communication terminal 2820 includes, as software, a host controller interface 2825 as part of a device driver, and a Wi-Fi bus interface 2826 including a host controller and a Wi-Fi IC. The host controller interface 2825 passes a command, data, and the like, conforming to a Wi-Fi protocol and being received from an application interface 232 through the network 240, to the host controller in the Wi-Fi bus interface 2826 in a format understandable to the host controller. Further, the host controller interface 2825 transmits data, device status, and the like, being passed from the host controller in the Wi-Fi bus interface 2826, to the application interface 232 through the network 240, The host controller in the Wi-Fi bus interface 2826 performs serial communication through Wi-Fi communication 2860 in accordance with the Wi-Fi a protocol, while exchanging a command, data, and the like with the host controller interface 2825. The Wi-Fi IC in the Wi-Fi bus interface 2826 controls a signal in the Wi-Fi communication 2860 in accordance with a Wi-Fi communication specification.

The Wi-Fi device 2810 includes, as software, a Wi-Fi has interface 2816 in the Wi-Fi device 2810 that is connected to the Wi-Fi bus interface 2826 in the communication terminal 2820 through the Wi-Fi communication 2860 and exchanges a signal with the Wi-Fi has interface 2826. Further, the Wi-Fi device 2810 includes an endpoint 2817 of control information, storing a descriptor including device information and control information, and an endpoint 2818 storing input-output data.

By such connection, the communication terminal 2820 and the Wi-Fi device 2810 perform physical-level communication by the own Wi-Fi bus interfaces 2826 and 2816. Further by a system-level control transfer through the application interface 232, the network 240, and the host controller interface 2825, control communication as basic processing is provided between application software 231 and the endpoint 2817 through a control pipe 2851. Further in an application-level data transfer, Wi-Fi data communication as each method of a device class is provided between the application software 231 and the endpoint 2818 through a data pipe group 2852.

As described above, a unified communication channel (pipe) can be formed by network communication between the application interface 232 in the host 230 and the host controller interface 2825 in the communication terminal 2820 through the network 240 and serial communication between the Wi-Fi bus interfaces 2826 and 2816 through the Wi-Fi communication.

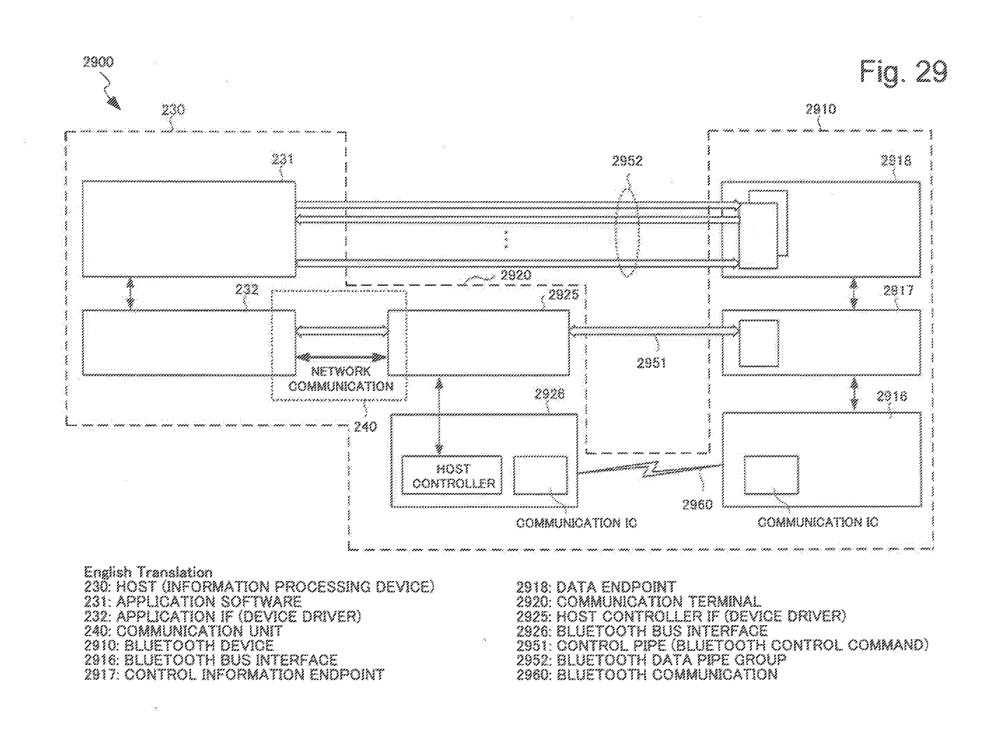

FIG. 29 is a diagram illustrating a concept of another information processing system 2900 according to the eighth example embodiment. FIG. 29 illustrates a case that a remote communication terminal is connected to a device by Bluetooth® communication. Note that, in FIG. 29, a same reference sign is given to a component similar to a component in FIG. 2B, and description thereof is omitted.

The information processing system 2900 in FIG. 29 includes a host 230 as an information processing device, a remote communication terminal 2920 connected to the host 230 through a network 240, and a Bluetooth® device 2910 connected to the communication terminal 2920 by Bluetooth® wireless communication.

The communication terminal 2920 includes, as software, a host controller interface 2925 as part of a device driver, and a Bluetooth® bus interface 2926 including a host controller and a Bluetooth® IC. The host controller interface 2925 passes a command, data, and the like, conforming to a Bluetooth® protocol and being received from an application interface 232 through the network 240, to the host controller in the Bluetooth® bus Interface 2926 in a format understandable to the host controller. Further, the host controller interface 2925 transmits data, device status, and the like, being passed from the host controller in the Bluetooth® bus interface 2926, to the application interface 232 through the network 240. The host controller in the Bluetooth® bus interlace 2926 performs serial communication through Bluetooth® communication 2960 in accordance with the Wi-Fi protocol, while exchanging a command, data, and the like with

the host controller Interface 2925. The Bluetooth® IC in the Bluetooth® bus interface 2926 controls a signal In the Bluetooth® communication 2960 in accordance with a Bluetooth® communication specification.

The Bluetooth® device 2910 includes, as software, a Bluetooth® bus interface 2916 in the Bluetooth® device 2910 that is connected to the Bluetooth® bus interface 2926 in the communication terminal 2920 through the Bluetooth® communication 2960 and exchanges a signal with the Bluetooth® bus interface 2926. Further, the Bluetooth® device 2910 includes an endpoint 2917 of control information, storing a descriptor including device Information and control information, and an endpoint 2918 storing input-output data.

By such connection, the communication terminal 2920 and the Bluetooth® device 2910 perform physical-level communication by the own Bluetooth® bus interfaces 2926 and 2916. Further, by a system-level control transfer through the application interface 232, the network 240, and the host controller interface 2925, control communication as basic processing is provided between application software 231 and the endpoint 2917 through a control pipe 2951. Further, in an application-level data transfer, Bluetooth® data communication as each method of a device class is provided between the application software 231 and the endpoint 2918 through a data pipe group 2952.

As described above, a unified communication channel (pipe) can be formed by network communication between the application interface 232 in the host 230 and the host controller Interface 2925 in the communication terminal 2920 through the network 240, and serial communication between the Bluetooth® bus interfaces 2926 and 2916 through the Bluetooth® communication.

While the eighth example embodiment has been illustrated with Wi-Fi wireless communication and Bluetooth® wireless communication as examples of short-distance wireless communication (proximity wireless communication), a similar effect may be provided with a similar configuration in another type of communication such as infrared communication.

Even when a remotely connected device is connected by short-distance wireless communication (proximity wireless communication), the eighth example embodiment enables the device to be operated in a same manner as a device directly connected to an information processing device, similarly to the aforementioned example embodiments.

<Ninth Example Embodiment>

Next, an information processing system according to a ninth example embodiment of the present invention will be described. The information processing system according to the ninth example embodiment differs from the aforementioned second to eighth example embodiments in that a plurality of devices at different locations are connected to an information processing device through a network. The remaining configuration and operation are similar to the second to seventh example embodiments, and therefore a same configuration and a same operation are respectively given same reference signs, and detailed description thereof is omitted.

<<Concept of information Processing System>>

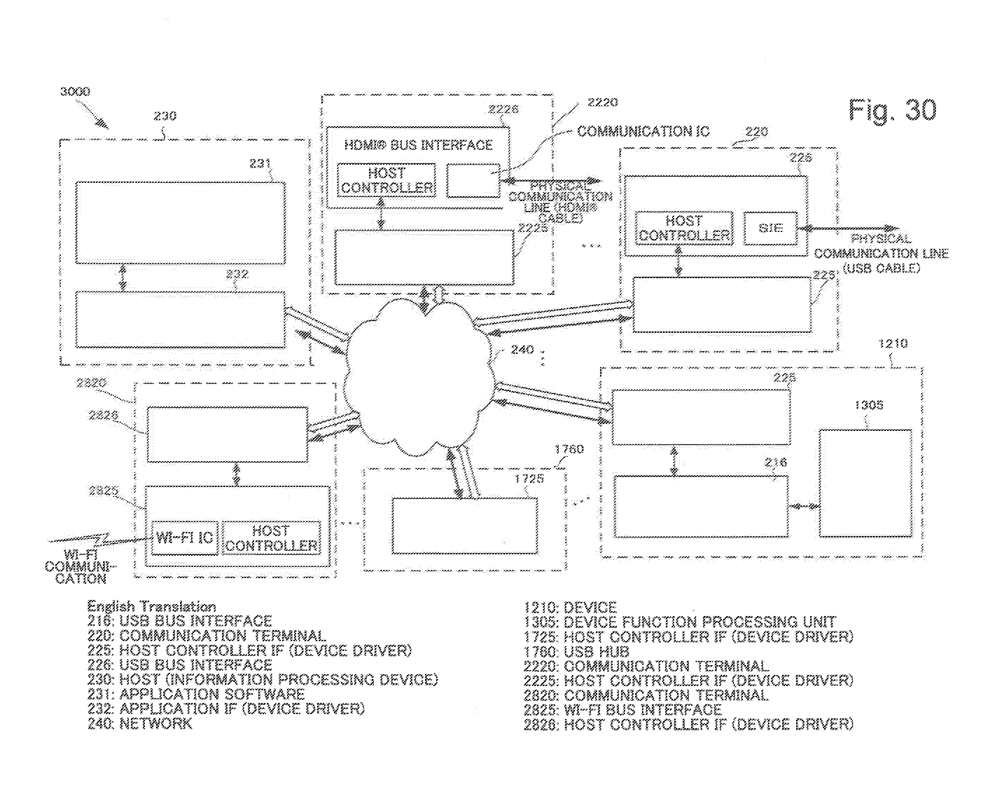

FIG. 30 is a diagram illustrating a concept of an information processing system 3000 according to the ninth example embodiment. Note that, In FIG. 30, a same reference sign is given to a component similar to a component in FIGS. 2B, 12, 17, or 22, Further, while FIG. 30 does not illustrate the communication terminals in FIGS. 24 and 26, the terminals may be connected to an information processing device 230 through a network 240 in FIG. 30 to remotely extend serial bus control.

In FIG. 30, the Information processing device 230 is connected to, through the network, the communication terminal 220 in FIG. 2B having a USB connection function, the device 1210 in FIG. 12 having a USB connection function, the USB hub 1760 in FIG. 17 having a USB hub function, the communication terminal 2220 in FIG. 22 having an HDMI® connection function, and the communication terminal 2420 in FIG. 28 having a Wi-Fi communication function, thus enabling a plurality of serial bus connections.

The ninth example embodiment enables a plurality of remote devices freely connected at different locations to be operated in a same manner as a device directly connected to an Information processing device.

<Tenth Example Embodiment>

Next, an information processing system according to a tenth example embodiment of the present invention will be described. The information processing system according to the tenth example embodiment differs from the aforementioned second to ninth example embodiments in that different types of data are communicated between an information processing device 230 (virtual PC) and a communication terminal 220 connected to a device. That is to say, according to the tenth example embodiment, an application IF in the information processing device 230 and a host controller IF in the communication terminal 220 are separated at parts different from the second example embodiment. For example, when an entire device driver including a host controller chip (HC) is provided by software, a set of a host controller driver and a host controller chip in particular is separated in various layers in consideration of communication efficiency and a communication rate. Then, information between separated layers is designed to be communicated through a network between the information processing device 230 and the communication terminal 220. The remaining configuration and operation are similar to the second to ninth example embodiments, and therefore a same configuration and a same operation are respectively given same reference signs, and detailed description thereof Is omitted.

(Data Transmission Example)

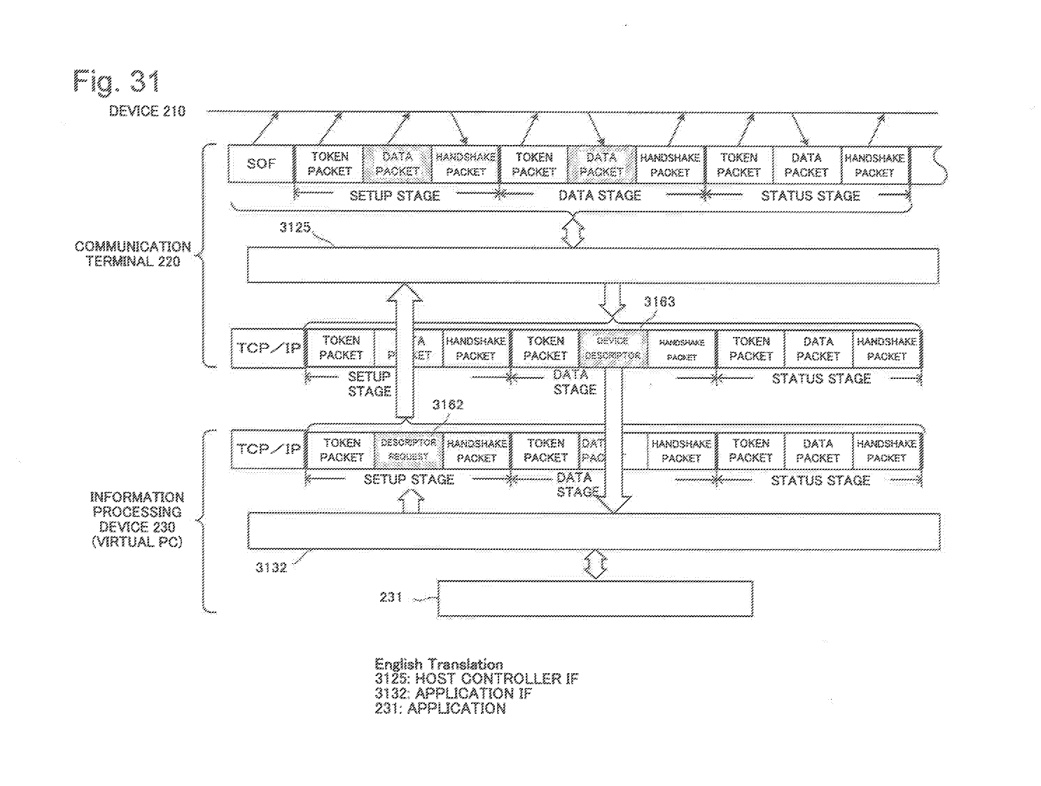

FIG. 31 is a diagram illustrating data transmission in the information processing system according to the tenth example embodiment. FIG. 31 is a diagram illustrating a descriptor acquisition procedure of a USB connected USB device, similarly to FIG. 6C. Accordingly, in FIG. 31, a same reference sign is given to a component similar to a component in FIG. 6C, and description thereof is omitted.

A descriptor set to a device 210 is acquired by a USB request such as GET DESCRIPTOR. A frame including a USB protocol of a USB request being a control transfer is exchanged between the information processing device 230 and fee device 210. Each control transfer is composed of a setup stage, a data stage, and a status stage. Each stage is composed of a token packet, a data packet, and a handshake packet, A descriptor is acquired in a data packet in each data stage. A descriptor acquired from the device 210 is inserted Into a frame IP encapsulated by an IP header and a TCP header, and is transmitted from a mobile terminal 220 to the information processing device 230.

In response to a device input-output request by an application 231, an application Interface 3132 in the information processing device 230 first generates a frame including a USB protocol of a USB request (GET DESCRIPTOR) and passes the frame to a communication control unit 401, in order to check a connected device.

The frame including the USB request (GET DESCRIPTOR) IP encapsulated by an IP header and a TCP header is received and IP decapsulated by a communication control unit 501 in the communication terminal 220. The USB request (GET DESCRIPTOR) is passed to a host controller interface 3125. The host controller interface 3125 instructs a USB bus interlace 226 (unillustrated) to transfer each packet to the device 210 over a USB bus, in accordance with the frame including fee USB protocol of the USB request (GET DESCRIPTOR).

The host controller interface 3125 passes a frame including, as a device descriptor 3163, a data packet received from the device 210 in a data stage to the communication control unit 501. The frame including the device descriptor 3163 IP encapsulated by an IP header and a TCP header is transmitted from the communication control unit 501 in the communication terminal 220 to the communication control unit 401 in the information processing device 230.

When the communication control unit 401 in the information processing device passes a frame including the decapsulated device descriptor 3163 to the application interface 3132, the application interface 3132 makes notification of connected device information in response to the device input-output request by the application 231.

Similar data transmission is subsequently performed in another control transfer, a bulk transfer, an interrupt transfer, and an isochronous transfer. The host controller interface 3125 and the USB bus interface 226 may be integrated into one piece of software.

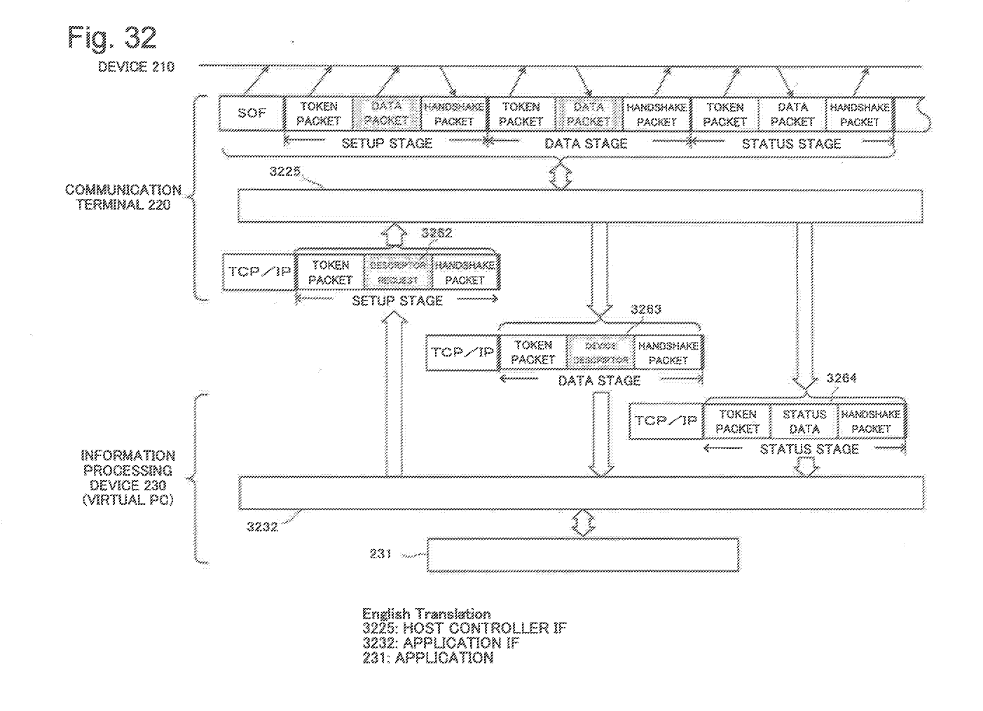

FIG. 32 is a diagram illustrating another type of data transmission in the information processing system according to the tenth example embodiment FIG. 32 is a diagram illustrating a descriptor acquisition procedure of a USB device connected by USB. similarly to FIGS. 6C and 31. Accordingly, in FIG. 32, a same reference sign is given to a component similar to a component in FIGS. 6C and 31, and description thereof is omitted.

A descriptor set to a device 210 is acquired by a USB request such as GET DESCRIPTOR. A control transfer including a USB protocol of a USB request is composed of a setup stage, a data stage, and a status stage. Each stage is composed of a token packet, a data packet, and a handshake packet. Each of a setup stage including a USB protocol of a USB request being a control transfer, a data stage, and a status stage is exchanged between an information processing device 230 and the device 210. A descriptor is acquired in a data packet in each data stage. A descriptor acquired from, the device 210 is inserted into a data stage IP encapsulated by art IP header and a TCP header, and is transmitted from a mobile terminal 220 to the information processing device 230.

In response to a device input-output request by an application 231, an application interface 3232 in the information processing device 230 first generates a setup stage including a USB protocol of a USB request (GET DESCRIPTOR) and passes the setup stage to a communication control unit 401, in order to check a connected device.

The setup stage including the USB request (GET DESCRIPTOR) IP encapsulated by an IP header and a TCP header is received and IP decapsulated by a communication control unit 501 in die communication terminal 220. The USB request (GET DESCRIPTOR) is passed to a host controller interface 3225. The host controller interface 3225 instructs a USB bus interface 226 (unillustrated) to transfer each packet to the device 210 over a USB bus, in accordance with the setup stage including the USB protocol of the USB request (GET DESCRIPTOR).

The host controller interface 3225 passes a data stage including, as a device descriptor 3263, a data packet received from the device 210 in the data stage to the communication control unit 501, The data stage including the device descriptor 3263 IP encapsulated by an IP header and a TCP header is transmitted from the communication control unit 501 in the communication terminal 220 to the communication control unit 401 in the information processing device 230.

When the communication control unit 401 in the information processing device passes the data stage including the decapsulated device descriptor 3263 to the application interface 3232, the application interface 3232 makes notification of connected device information in response to the device input-output request by the application 231.

Further, the host controller interface 3225 passes a status stage including, as status data 3264, a data packet received from the device 210 in the status stage to the communication control unit 501. The status stage including the status data 3264 IP encapsulated by an IP header and a TCP header is transmitted from the communication control unit 501 in the communication terminal 220 to the communication control unit 401 in the information processing device 230.

When the communication control unit 401 in the information processing device passes the status stage including the decapsulated status data 3264 to the application interface 3232, the application interface 3232 makes notification of connected device information in response to the device input-output request by the application 231.

While the application Interface 3232 does not make a determination of a handshake packet in the description above, the application interface 3232 may be configured to check a handshake packet it) each stage.

Similar data transmission is subsequently performed in another control transfer, a bulk transfer an interrupt transfer, and an isochronous transfer. The host controller interface 3225 and the USB bus interface 226 may be integrated into one piece of software.

Whether communication between an information processing device (virtual PC) and a communication terminal is communication separating the own drivers on a frame-by-frame basis or on a stage-by-stage basis, the tenth example embodiment enables a USB device connected to a remote communication terminal to be operated in a same manner as a USB device directly connected to an information processing device.

<Other Example Embodiments>

While the host as an information processing device according to the aforementioned example embodiments has been described as a stand-alone PC, the host according to the aforementioned example embodiments may be a virtual PC constructed in a cloud server. When the host according to the aforementioned example embodiments is a virtual PC, a device connection history accumulated in a cloud server may be utilized as knowledge to configure suitable connection from the virtual PC to a remote device.

Further, while the present invention has been described with reference to the example embodiments, the present invention is not limited to the aforementioned example embodiments. Various changes and modifications that can be understood by a person skilled in the art may be made to the configurations and details of the present invention, within the scope of the present invention. Further, a system or a device in which different features included in the respective example embodiments are appropriately combined is also included in the scope of the present invention.

Further, the present invention may be applied to a system composed of a plurality of pieces of equipment or a single device. Additionally, the present invention is applicable when an information processing program providing a function according to the example embodiments Is supplied to a system or a device directly or remotely. Accordingly, a program installed on a computer for providing a function of the present invention by the computer, a medium storing the program, and a World Wide Web (WWW) server for downloading die program are also included in the scope of the present invention. At least a non-transitory computer readable medium storing a program that causes a computer to perform processing steps included in the aforementioned example embodiments, in particular, is included in the scope of the present invention.

This application is related to Japanese Patent Applications (Japanese Patent Application No. 2014-235109, Japanese Patent Application No. 2014-235110, and Japanese Patent Application No. 2014-235111) filed on the same day, the disclosure of which is hereby incorporated by reference thereto in its entirety.

This application claims priority based on Japanese Patent Application No. 2014-235108 filed on Nov. 19, 2014, the disclosure of which is hereby incorporated by reference thereto in its entirety.

1. An information processing system comprising:
a device;
a device control unit than controls the device;
a device interface unit that interfaces with the device control unit;
an information processing device that includes an application and an application interface unit that interfaces with the application; and
a channel establishment unit that, when being connected to the application interface unit and the device interface unit, establishes a control channel and a data channel between the application and the device.

2. The information processing system according to claim 1, wherein
the device control unit and the device interface unit are included in a communication terminal, and
the communication terminal and the device are connected by a serial bus. cm 3. The information processing system according to claim 1, wherein
the device, the device control unit, and the device interface unit are included in one enclosure.

4. The information processing system according to claim 2, wherein
the information processing device further includes a delivery unit that delivers the device interface unit to the communication terminal.

5. The information processing system according to claim 1, wherein
the application interface unit receives an input or output operation of a file from the application and, in response to the input or output operation, establishes the control channel to communicate control information of the device control unit, and establishes the data channel to communicate data.

6. The information processing system according to claim 5, wherein
the device interface unit establishes the control channel associating with control information of the device control unit, and
establishes the data channel associating with data of the device control unit.

7. The information processing system according to claim 1, wherein
the device and the device control unit are connected by a universal serial bus (USB), a High-Definition Muitimedia Interface (HDMI)®, a small computer system interface (SCSI), an interface with an SD memory card, or short-distance wireless communication.

8. An information processing method comprising:
by an information processing device, initiating an application;
activating an application interface unit that interfaces with the application;
connecting, through a communication unit, the application interface unit to a device interface unit that interfaces with a device control unit that controls a device; and
establishing a control channel and a data channel between the application and the device.

9. An information processing device comprising:
an application;
an application interface unit that interfacing with the application; and
a channel establishment unit that connects, through a communication unit, the application interface unit to a device interface unit that interfaces with a device control unit that controls a device, and establishes a control channel and a data channel between the application and the device.

10.-13. (canceled)
